(19) United States
(12) Patent Application Publication
(10) Pub. No.: US 2015/0212681 A1
(43) Pub. Date: Jul. 30, 2015

(54) HEAD-MOUNTED DISPLAY, UNLOCKING SYSTEM, AND METHOD FOR CONTROLLING UNLOCKING SYSTEM

(71) Applicant: OLYMPUS CORPORATION, Tokyo (JP)

(72) Inventors: Arata SHINOZAKI, Tokyo (JP); Mitsunori KUBO, Tokyo (JP); Akio KOSAKA, Tokyo (JP); Hidekazu IWAKI, Tokyo (JP); Takayuki NAKATOMI, Tokyo (JP)

(73) Assignee: OLYMPUS CORPORATION, Tokyo (JP)

(21) Appl. No.: 14/682,500

(22) Filed: Apr. 9, 2015

Related U.S. Application Data
(63) Continuation of application No. PCT/JP2013/075624, filed on Sep. 24, 2013.

(30) Foreign Application Priority Data
Oct. 10, 2012 (JP) 2012-224801

(51) Int. Cl. G06F 3/0484; G06F 3/0488; G06F 3/0481; G06F 3/01; G06F 1/16; G02B 27/01

(52) U.S. Cl. CPC G06F 3/0484; G06F 1/163; G06F 1/1601; G02B 27/017; G06F 3/0481; G06F 3/012; G06F 3/0488

(57) ABSTRACT

A head-mounted display includes a display section that displays a display image, and a display control section that performs a control process that displays the display image on the display section. The display control section displays an unlocking screen on the display section, the unlocking screen being used by the user to unlock the head-mounted display, and displays an unlocked state notification screen on the display section when the head-mounted display has been unlocked using the unlocking screen, the unlocked state notification screen notifying the user that the head-mounted display has been unlocked.

### CROSS REFERENCE TO RELATED APPLICATION

This application is a continuation of International Patent Application No. PCT/JP2013/075624, having an international filing date of Sep. 24, 2013, which designated the United States, the entirety of which is incorporated herein by reference. Japanese Patent Application No. 2012-224801 filed on Oct. 10, 2012 is also incorporated herein by reference in its entirety.

### BACKGROUND

The present invention relates to a head-mounted display, an unlocking system, a method for controlling an unlocking system, and the like.

A head-mounted display (HMD) has been known as a display device that is worn on a head.

The HMD may be used independently, but may normally be used in combination with a portable terminal device or the like. For example, the HMD may be used as a display section for a terminal device (see JP-A-2003-279881 and JP-A-2012-88474) when the HMD is used in combination with a portable terminal device or the like.

JP-A-2003-279881 discloses an invention that displays information that has been input by the user through a user interface section (e.g., button, key, dial, touch panel, or pen) of a personal digital assistant (PDA) on the display section of the PDA and the display section of HMD.

JP-A-2012-88474 discloses an invention in which a terminal device detects the position of a finger of the user, and a finger image is displayed on the display section of the HMD based on the position of the finger detected by the terminal device. A keyboard image is also displayed on the display section of the HMD so that the keyboard image is superimposed on the finger image.

### SUMMARY

According to one aspect of the invention, there is provided a head-mounted display that is worn on a head of a user, the head-mounted display comprising:

a display section that displays a display image; and

a display control section that performs a control process that displays the display image on the display section,

the display control section displaying an unlocking screen on the display section, the unlocking screen being used by the user to unlock the head-mounted display, or a terminal device that is communicably connected to the head-mounted display, and displaying an unlocked state notification screen on the display section when the head-mounted display or the terminal device has been unlocked using the unlocking screen, the unlocked state notification screen notifying the user that the head-mounted display or the terminal device has been unlocked.

According to another aspect of the invention, there is provided an unlocking system comprising:

a head-mounted display; and

a terminal device that is communicably connected to the head-mounted display,

the head-mounted display including:

a first display section that displays a first display image; and

a first display control section that performs a control process that displays the first display image on the first display section,

the terminal device including:

a second display section that displays a second display image; and

a second display control section that performs a control process that displays the second display image on the second display section,

the head-mounted display or the terminal device including:

a processing section that performs an unlocking determination process; and

an operation information acquisition section that acquires user operation information,

the first display control section displaying an unlocking screen for unlocking the head-mounted display or the terminal device on the first display section,

the processing section determining whether or not the head-mounted display or the terminal device has been unlocked based on the user operation information that has been input using the unlocking screen, and

the first display control section displaying an unlocked state notification screen on the first display section when it has been determined that the head-mounted display or the terminal device has been unlocked, the unlocked state notification screen notifying that the head-mounted display or the terminal device has been unlocked.

According to another aspect of the invention, there is provided a method for controlling an unlocking system that includes a head-mounted display, and a terminal device that is communicably connected to the head-mounted display, the method comprising:

displaying an unlocking screen for unlocking the head-mounted display or the terminal device on a first display section of the head-mounted display;

performing a display control process on a second display section of the terminal device;

acquiring user operation information;

determining whether or not the head-mounted display or the terminal device has been unlocked based on the acquired user operation information; and

displaying an unlocked state notification screen on the first display section when it has been determined that the head-mounted display or the terminal device has been unlocked, the unlocked state notification screen notifying that the head-mounted display or the terminal device has been unlocked.

### BRIEF DESCRIPTION OF THE DRAWINGS

FIGS. 1A and 1B illustrate a system configuration example according to one embodiment of the invention.

FIG. 2 is a view illustrating a first system configuration example in detail.

FIG. 3 is a view illustrating a second system configuration example in detail.

FIG. 4 illustrates another system configuration example according to one embodiment of the invention.

FIG. 5 illustrates a third system configuration example in detail.

FIGS. 6A to 6E are views illustrating an unlocking screen and an unlocking process.

FIGS. 7A to 7D are views illustrating an example of the arrangement of a plurality of optional images.

FIGS. 8A and 8B are views illustrating a process that selects an optional image based on the motion of a head.

FIG. 9 is a view illustrating a selection operation section and a selection settlement operation section provided to an HMD.

FIGS. 10A to 10C are views illustrating a method that selects an optional image using a touch panel.

FIGS. 11A and 11B are views illustrating a method that sets a display section of a terminal device to a non-display state.

FIG. 12 is a sequence diagram illustrating a process according to one embodiment of the invention.

FIG. 13 is a view illustrating an optional image that includes information that relates to a user.

FIGS. 14A to 14C are views illustrating an unlocking process that is performed based on the order of selection ranges that have been traced with a finger.

### DESCRIPTION OF EXEMPLARY EMBODIMENTS

A situation may occur in which the operation button or the like of the HMD or the terminal device is erroneously pressed due to collision with part of the body of the user, or the HMD or the terminal device is operated by a person other than the user when the user does not carry the HMD or the terminal device.

In order to prevent a situation in which the HMD or the terminal device is erroneously operated, and ensure security, the HMD or the terminal device may be locked so that the HMD or the terminal device can only be operated in a limited way. In such a case, the HMD or the terminal device is unlocked when it has been determined that a password or the like that has been input by the user is correct, for example.

However, a person other than the user may steal a glance at the key operation or the like when the user inputs the password to determine the password, and the password may leak. Specifically, when a person other than the user can easily steal the password, it is likely that the HMD or the like is easily unlocked by a person other than the user, and the effect of locking the HMD or the like decreases.

Several embodiments of the invention may provide a head-mounted display, an unlocking system, a method for controlling an unlocking system, and the like that make it difficult for a person other than the user to steal a glance at the information that is input by the user when the user unlocks the head-mounted display or the like.

According to one embodiment of the invention, the display control section displays the unlocking screen on the display section of the head-mounted display when the head-mounted display or the terminal device is locked. The display control section displays the unlocked state notification screen on the display section of the head-mounted display when the head-mounted display or the terminal device has been unlocked.

Since the unlocking screen and the unlocked state notification screen are displayed on the display section of the head-mounted display, it is possible to prevent a situation in which a person other than the user can easily steal a glance at the information that is input by the user when the user unlocks the head-mounted display or the terminal device.

The head-mounted display may include an operation information acquisition section that acquires user operation information, and a processing section that determines whether or not the head-mounted display or the terminal device has been unlocked based on the user operation information that has been input using the unlocking screen.

This makes it possible for the user to unlock the head-mounted display using only the head-mounted display, for example.

In the head-mounted display, the display control section may display the unlocking screen in which a plurality of optional images are arranged, on the display section, and the processing section may specify an optional image that has been selected from among the plurality of optional images arranged within the unlocking screen based on the acquired user operation information, determine whether or not a selection pattern of the optional image selected by the user coincides with an unlocking pattern, and determine that the head-mounted display or the terminal device has been unlocked when it has been determined that the selection pattern coincides with the unlocking pattern.

This makes it possible for the user to unlock the head-mounted display or the terminal device by settling to select the optional images displayed on the display section of the head-mounted display in the same order as that of the unlocking pattern.

In the head-mounted display,

the display control section may display the unlocking screen in which the plurality of optional images are arranged in one row or one column, or the unlocking screen in which the plurality of optional images are arranged in a two-dimensional array having i rows and j columns (i and j are positive integers, provided that at least one of i and j is equal to or larger than 2), on the display section.

This makes it possible for the user to sequentially set the optional images to the selected state by performing an identical operation, and makes it more difficult for a person other than the user to decipher the input information, for example.

In the head-mounted display,

the display control section may display the unlocking screen in which the plurality of optional images are arranged at random positions, on the display section.

This makes it more difficult for a person other than the user to decipher the input information, for example.

In the head-mounted display,

the display control section may display a first unlocking screen on the display section as the unlocking screen at a first display timing, and may display a second unlocking screen on the display section as the unlocking screen at a second display timing that differs from the first display timing, the second unlocking screen differing from the first unlocking screen as to arrangement positions of the plurality of optional images.

This makes it possible to change the optional image that is set to the selected state when the user has performed an identical operation at a different timing, and makes it more difficult for a person other than the user to decipher the input information, for example.

In the head-mounted display,

the display control section may display the unlocking screen in which arrangement positions of the plurality of optional images are periodically changed, on the display section.

This makes it possible to change the optional image that is set to the selected state when the user has performed an identical operation at a timing that precedes or follows the timing at which the arrangement positions of the plurality of optional images are changed, and makes it more difficult for a person other than the user to decipher the input information, for example.

In the head-mounted display,

the processing section may set an optional image among the plurality of optional images to an initial selected state at an initial selection timing, and

the display control section may display the unlocking screen in which at least the optional image that has been set to the initial selected state is arranged, on the display section.

This makes it possible to automatically set an optional image among the plurality of optional images to the selected state at the start timing of the unlocking process, for example.

In the head-mounted display,

the processing section may set a kth optional image among first to Nth optional images to the initial selected state at a first initial selection timing (N is a positive integer, and k is an integer that satisfies 1≦k≦N), and may set an mth optional image among the first to Nth optional images to the initial selected state at a second initial selection timing that differs from the first initial selection timing (m is an integer that satisfies 1≦m≦N and k≠m).

This makes it possible to change the optional image that is set to the selected state when the user has performed an identical operation at a different timing, and makes it more difficult for a person other than the user to decipher the input information, for example.

In the head-mounted display,

the processing section may specify a selection direction based on the user operation information, the selection direction representing a direction in which an optional image among the plurality of optional images that is to be set to a selected state is situated within the unlocking screen with respect to an optional image among the plurality of optional images that has been set to the selected state.

This makes it possible to change the selection direction even when the user has performed an identical operation, and makes it more difficult for a person other than the user to decipher the input information, for example.

In the head-mounted display,

when the user operation information has been acquired by the operation information acquisition section when an rth optional image among first to Nth optional images has been set to the selected state (N is a positive integer, and r is an integer that satisfies 1≦r≦N),

the processing section may set the selection direction to a first direction at a first selection timing, setting an sth optional image that is situated in the first direction with respect to the rth optional image within the unlocking screen to the selected state (s is an integer that satisfies 1≦s≦N and r≠s), may set the selection direction to a second direction that differs from the first direction at a second selection timing that differs from the first selection timing, and may set a tth optional image that is situated in the second direction with respect to the rth optional image within the unlocking screen to the selected state (t is an integer that satisfies 1≦t≦N and r≠t).

This makes it possible to set the selection direction to a different direction every timing, and change the optional image that is set to the selected state when the user has performed an identical operation, and makes it more difficult for a person other than the user to decipher the input information, for example.

In the head-mounted display, the operation information acquisition section may acquire a motion sensor signal from a motion sensor as the user operation information.

This makes it possible to set an optional image among the plurality of optional images to the selected state corresponding to the motion of the body of the user, for example.

In the head-mounted display, the operation information acquisition section may acquire the motion sensor signal that represents the motion of the head of the user from the motion sensor, and the processing section may specify the motion of the head of the user based on the motion sensor signal, and specify a selection direction based on the motion of the head of the user, the selection direction representing a direction in which an optional image among the plurality of optional images that is to be set to a selected state is situated within the unlocking screen with respect to an optional image among the plurality of optional images that has been set to the selected state.

This makes it possible to set an optional image among the plurality of optional images to the selected state corresponding to the motion of the head of the user, for example.

In the head-mounted display,

the operation information acquisition section may acquire the user operation information from a user interface section that includes a selection operation section for performing a selection operation, and a selection settlement operation section for performing a selection settlement operation, and

the processing section may set an optional image among the plurality of optional images that has been set to a selected state to a non-selected state, and may set another optional image among the plurality of optional images to the selected state when it has been detected that the selection operation section has been operated based on the user operation information, and may settle that the optional image that has been set to the selected state is selected when it has been detected that the selection settlement operation section has been operated based on the user operation information.

This makes it possible to set an optional image among the plurality of optional images to the selected state corresponding to the operation performed by the user using the user interface section, for example.

In the head-mounted display,

the operation information acquisition section may acquire the user operation information from a terminal device that includes a touch panel that displays the display image, and detects the user operation information.

This makes it possible to set an optional image among the plurality of optional images to the selected state corresponding to the operation performed by the user using the touch panel, for example.

In the head-mounted display, the processing section may set the optional image that has been set to the selected state to a non-selected state, and set another optional image to the selected state when it has been detected that a flick has been performed on the touch panel based on the user operation information, and settle that the optional image that has been set to the selected state is selected when it has been detected that a tap has been performed on the touch panel based on the user operation information.

This makes it possible for the user to change the optional image that is set to the selected state by performing an intuitive flick operation, and settle to select the optional image that has been set to the selected state by performing an intuitive tap operation, for example.

In the head-mounted display, the processing section may set the optional image that has been set to the selected state to a non-selected state, and set another optional image to the selected state when it has been detected that a single tap has been performed on the touch panel based on the user operation information, and settle that the optional image that has been set to the selected state is selected when it has been detected that a double tap has been performed on the touch panel based on the user operation information.

This makes it possible for the user to perform the selection operation and the selection select operation by changing the number of taps performed on the touch panel, for example.

In the head-mounted display, the display control section may display the unlocking screen in which a plurality of optional images are arranged, on the display section, the plurality of optional images being a combination of at least one of an icon image, a character, a numeral, a symbol, and a figure.

This makes it possible to use the unlocking screen for which it is more difficult for a person other than the user to guess the screen state, for example.

In the head-mounted display,

the display control section may display the unlocking screen in which a plurality of optional images are arranged, on the display section, and may display the unlocked state notification screen on the display section when it has been determined that a selection pattern that has been specified based on the user operation information coincides with an unlocking pattern, the selection pattern being a pattern of optional images among the plurality of optional images that have been selected by the user.

This makes it possible for the user to unlock the head-mounted display or the terminal device by settling to select the optional images displayed on the display section of the head-mounted display in the same order as that of the unlocking pattern.

In the head-mounted display,

the display control section may display a first unlocking screen on the display section as the unlocking screen at a first display timing, and may display a second unlocking screen on the display section as the unlocking screen at a second display timing that differs from the first display timing, the second unlocking screen differing from the first unlocking screen as to arrangement positions of the plurality of optional images.

This makes it possible to change the optional image that is set to the selected state when the user has performed an identical operation at a different timing, and makes it more difficult for a person other than the user to decipher the input information, for example.

In the head-mounted display,

the display control section may display the unlocking screen in which an optional image among the plurality of optional images that has been set to an initial selected state at an initial selection timing is arranged, on the display section.

This makes it possible to automatically set an optional image among the plurality of optional images to the selected state at the start timing of the unlocking process, for example.

In the head-mounted display,

the display control section may display the unlocking screen in which a kth optional image among first to Nth optional images has been set to the initial selected state at a first initial selection timing, on the display section (N is a positive integer, and k is an integer that satisfies 1≦k≦N), and may display the unlocking screen in which an mth optional image among the first to Nth optional images has been set to the initial selected state at a second initial selection timing that differs from the first initial selection timing, on the display section (m is an integer that satisfies 1≦m≦N and k≠n).

This makes it possible to change the optional image that is set to the selected state when the user has performed an identical operation at a different timing, and makes it more difficult for a person other than the user to decipher the input information, for example.

The head-mounted display may further comprise:

an operation information acquisition section that acquires user operation information,

when the user operation information has been acquired by the operation information acquisition section when an rth optional image among first to Nth optional images has been set to a selected state (N is a positive integer, and r is an integer that satisfies 1≦r≦N),

the display control section may display the unlocking screen in which an sth optional image that is situated in a first direction with respect to the rth optional image is set to the selected state, on the display section at a first selection timing (s is an integer that satisfies 1≦s≦N and r≠s), and may display the unlocking screen in which a tth optional image that is situated in a second direction that differs from the first direction with respect to the rth optional image is set to the selected state, on the display section at a second selection timing that differs from the first selection timing (t is an integer that satisfies 1≦t≦N and r≠t).

This makes it possible to set the selection direction to a different direction every timing, and change the optional image that is set to the selected state when the user has performed an identical operation, and makes it more difficult for a person other than the user to decipher the input information, for example.

The head-mounted display may include an operation information acquisition section that acquires a motion sensor signal from a motion sensor as the user operation information.

This makes it possible to set an optional image among the plurality of optional images to the selected state corresponding to the motion of the body of the user, for example.

The head-mounted display may further comprise:

an operation information acquisition section that acquires the user operation information from a user interface section that includes a selection operation section for performing a selection operation, and a selection settlement operation section for performing a selection settlement operation,

the display control section may display the unlocking screen in which an optional image among the plurality of optional images that has been set to a selected state is set to a non-selected state, and another optional image among the plurality of optional images is set to the selected state, on the display section when it has been detected that the selection operation section has been operated based on the user operation information, and may display the unlocking screen in which it is settled that the optional image that has been set to the selected state is selected, on the display section when it has been detected that the selection settlement operation section has been operated based on the user operation information.

This makes it possible to set an optional image among the plurality of optional images to the selected state corresponding to the operation performed by the user using the user interface section, for example.

Since the unlocking screen and the unlocked state notification screen are displayed on the display section of the head-mounted display, it is possible to prevent a situation in which a person other than the user can easily steal a glance at the information that is input by the user when the user unlocks the head-mounted display or the terminal device.

In the unlocking system,

the first display control section may display the unlocking screen on the first display section during an unlocking process, and

the second display control section may set the second display section to a non-display state during the unlocking process, and setting the second display section to a display state when the processing section has determined that the head-mounted display has been unlocked.

This makes it possible to prevent a situation in which a person other than the user steals a glance at the display section of the terminal device, and the unlocking password or the like leaks, for example.

Exemplary embodiments of the invention are described below. An outline of the exemplary embodiments of the invention, and a system configuration example according to the exemplary embodiments of the invention will be described first. The method employed in connection with the exemplary embodiments of the invention will then be described, and a specific process will be described in detail thereafter using a flowchart. Note that the following exemplary embodiments do not in any way limit the scope of the invention laid out in the claims. Note also that all of the elements described below in connection with the exemplary embodiments should not necessarily be taken as essential elements of the invention.

### 1. Outline

A head-mounted display (HMD) has been known as a display device that is worn on a head.

The HMD may be used independently, but may normally be used in combination with a portable terminal device or the like. For example, the HMD may be used as a display section for a terminal device (see JP-A-2003-279881 and JP-A-2012-88474) when the HMD is used in combination with a portable terminal device or the like.

JP-A-2003-279881 discloses an invention that displays information that has been input by the user through a user interface section (e.g., button, key, dial, touch panel, or pen) of a personal digital assistant (PDA) on the display section of the PDA and the display section of HMD. According to the invention disclosed in JP-A-2003-279881, the user can observe a larger display image when the display area of the display section of the HMD is larger than the display area of the display section of the PDA, for example.

JP-A-2012-88474 discloses an invention in which a terminal device detects the position of a finger, and a finger image is displayed on the display section of the HMD based on the position of the finger detected by the terminal device. A keyboard image is also displayed on the display section of the HMD so that the keyboard image is superimposed on the finger image. According to the invention disclosed in JP-A-2012-88474, the user can perform a key input while observing only the display section of the HMD, for example.

A situation may occur in which the operation button or the like of the HMD or the terminal device is erroneously pressed due to collision with part of the body of the user, or the HMD or the terminal device is operated by a person other than the user when the user does not carry the HMD or the terminal device.

In order to prevent a situation in which the HMD or the terminal device is erroneously operated, and ensure security, the HMD or the terminal device may be locked so that the HMD or the terminal device can only be operated in a limited way. In such a case, the HMD or the terminal device is unlocked when it has been determined that a password or the like that has been input by the user is correct, for example. The method disclosed in JP-A-2003-279881 or JP-A-2012-88474 has also been used when unlocking the HMD or the terminal device.

However, a person other than the user may steal a glance at the key operation or the like when the user inputs the password to determine the password, and the password may leak.

For example, the invention disclosed in JP-A-2003-279881 displays the information input by the user on not only the display section of the HMD, but also the display section of the PDA. However, a person other than the user can easily steal a glance at the display section of the PDA, and the key operation. Therefore, it is likely that a person other than the user can easily steal the password input by the user when applying the invention disclosed in JP-A-2003-279881.

Specifically, when a person other than the user can easily steal the password, it is likely that the HMD or the like is easily unlocked by a person other than the user, and the effect of locking the HMD or the like decreases.

When the password is input using the invention disclosed in JP-A-2012-88474, it is possible to prevent a situation in which a person other than the user can easily guess the password by randomly changing the keypad layout of the numeric keypad image that is superimposed on the blank keyboard image. In this case, however, since it is necessary to provide an image processing section that superimposes the numeric keypad image on the blank keyboard image in addition to the imaging section, the configuration of the HMD becomes complex, and the production cost increases. Moreover, it is also difficult to implement the process that superimposes the numeric keypad image on the blank keyboard image.

In view of the above situation, several embodiments of the invention provide an HMD and an unlocking system that make it possible to prevent a situation in which a person other than the user easily steals a glance at the input information that has been input by the user when the user unlocks the HMD or the terminal device, without providing an imaging section, an image processing section that superimposes an image on another image, and the like.

More specifically, operation information that has been input using a user interface section of the HMD, the motion of the head of the user, or the like is acquired as information input by the user, and an unlocking determination process is performed based on the acquired information. The input information is displayed only on the display section of the HMD without displaying the input information on the display section of the terminal device. This makes it possible to prevent a situation in which a person other than the user can easily steal a glance at (or steal) the information that is input by the user when the user unlocks the HMD or the terminal device.

Note that an unlocking determination process may be performed by a processing section of the HMD, or may be performed by the terminal device. The details thereof are described below using three system configuration examples.

### 2. System Configuration Example

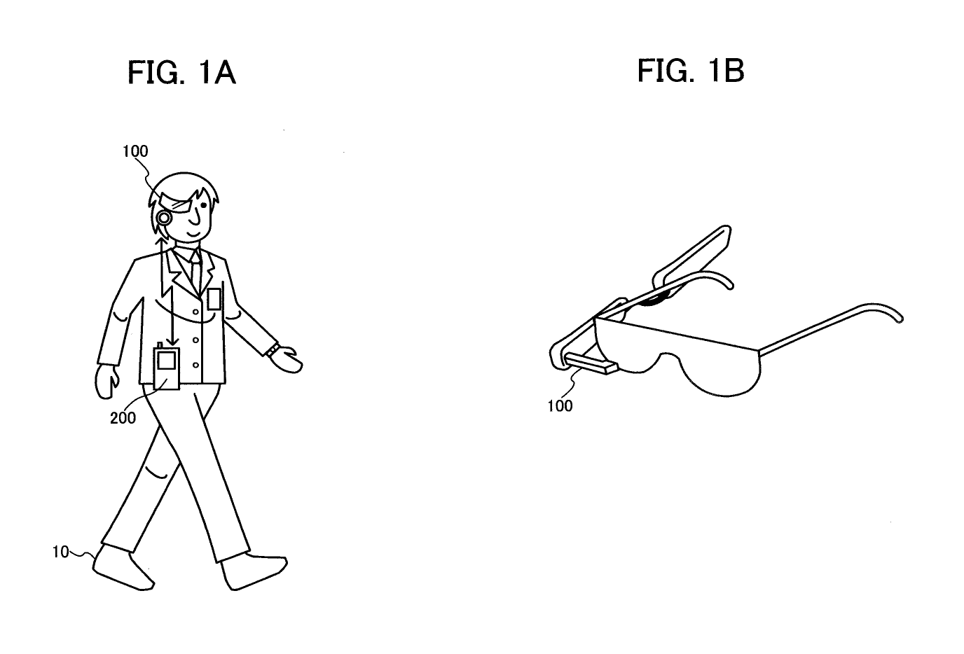

FIG. 1A illustrates a state in which a user 10 wears (utilizes) a head-mounted display (HMD) 100 according to one embodiment of the invention. In FIG. 1A, the user 10 wears the head-mounted display 100 on his head, and carries a terminal device 200. The head-mounted display 100 according to one embodiment of the invention has the shape illustrated FIG. 1B, and is attached to the side of eyeglasses.

### 2.1 First System Configuration Example

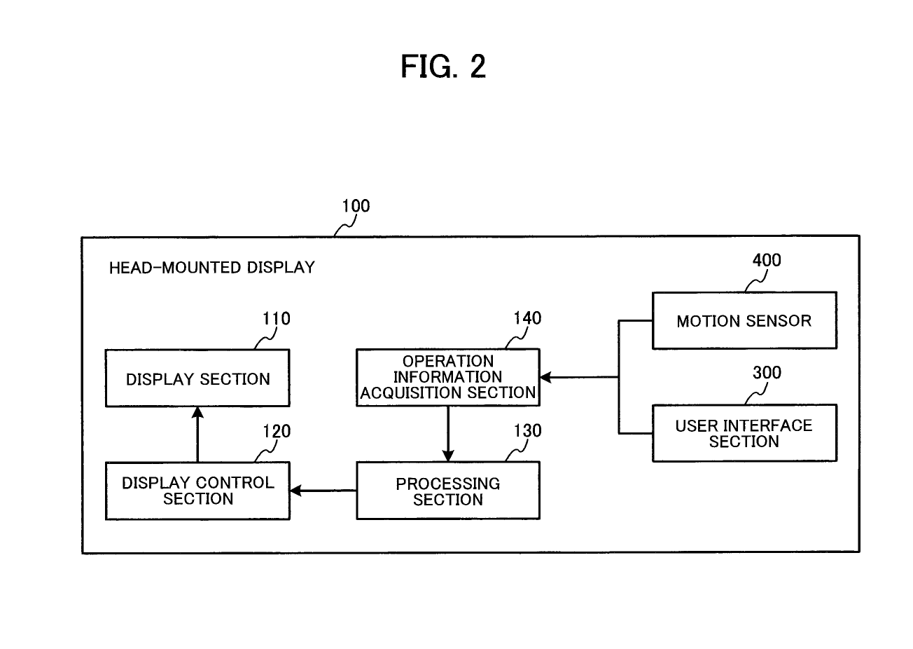

FIG. 2 illustrates a detailed configuration example of the head-mounted display as a first system configuration example according to one embodiment of the invention. The first system configuration example is mainly used when unlocking the head-mounted display. Note that the application of the first system configuration example is not limited thereto.

The head-mounted display 100 includes a display section 110, a display control section 120, a processing section 130, an operation information acquisition section 140, a user interface section 300, and a motion sensor 400. Note that the configuration of the head-mounted display 100 is not limited to the configuration illustrated in FIG. 2. Various modifications may be made, such as omitting some of the elements illustrated in FIG. 2, or adding other elements. Note that a communication section is omitted in FIG. 2.

The connection relationship between each section is described below. The display control section 120 is connected to the display section 110. The processing section 130 is connected to the display control section 120, and the operation information acquisition section 140 is connected to the processing section 130. The user interface section 300 and the motion sensor 400 are connected to the operation information acquisition section 140 through cable or wireless communication.

The process performed by each section according to the first system configuration example is described below.

The display section 110 displays a display image according to a display control process performed by the display control section 120 (described below). The display section 110 may be implemented by a liquid crystal display, an organic EL display, electronic paper, or the like. The display section 110 may be a deflection section such as a half mirror, or may be a projection section that projects the display image directly onto the eye of the user.

The display control section 120 performs the control process that displays the display image on the display section 110.

The processing section 130 performs an unlocking process and the like. Note that the function of the display control section 120 and the function of the processing section 130 may be implemented by hardware such as a processor (e.g., CPU) or an ASIC (e.g., gate array), a program, or the like.

The operation information acquisition section 140 is connected to at least one of the user interface section 300 and the motion sensor 400 (described below) through cable or wireless communication, and acquires user operation information. Note that the operation information acquisition section 140 need not necessarily acquire the user operation information from one of the user interface section 300 and the motion sensor 400. The operation information acquisition section 140 may acquire the user operation information from both the user interface section 300 and the motion sensor 400.

The user interface section 300 acquires input information that has been input by the user. The user interface section 300 may be an operation section. In this case, the user interface section 300 may be implemented by a keyboard, a mouse, a touch panel, a button, a camera, a microphone, or the like. The user interface section 300 may be included in the head-mounted display 100 (see FIG. 2), or may be an independent device that is connected to the head-mounted display 100 through cable or wireless communication.

The motion sensor 400 detects a motion sensor signal, and transmits the motion sensor signal to the operation information acquisition section 140. The motion sensor 400 may be an acceleration sensor, for example. In this case, the motion sensor 400 detects an acceleration sensor signal as the motion sensor signal. The acceleration sensor includes an element (device) that changes in resistance value due to external force, and detects triaxial acceleration information, for example. The acceleration sensor may be a hexaxial acceleration sensor that detects the moment around each axis in addition to the triaxial force. The motion sensor is not limited to an acceleration sensor, but may be a direction (orientation) sensor such as a terrestrial magnetism sensor, a gyro sensor, or the like. The direction sensor measures the direction (angle: 0 to) 360° of the sensor. The terrestrial magnetism sensor includes an element (device) that changes in resistance value or impedance value corresponding to the magnitude of a magnetic field, for example, and detects triaxial terrestrial magnetism information. The motion sensor may be a sensor having the functions of the terrestrial magnetism sensor, the acceleration sensor, and the gyro sensor. The motion sensor 400 may be included in the head-mounted display 100 (see FIG. 2), or may be connected to the head-mounted display 100 through cable or wireless communication.

### 2.2 Second System Configuration Example

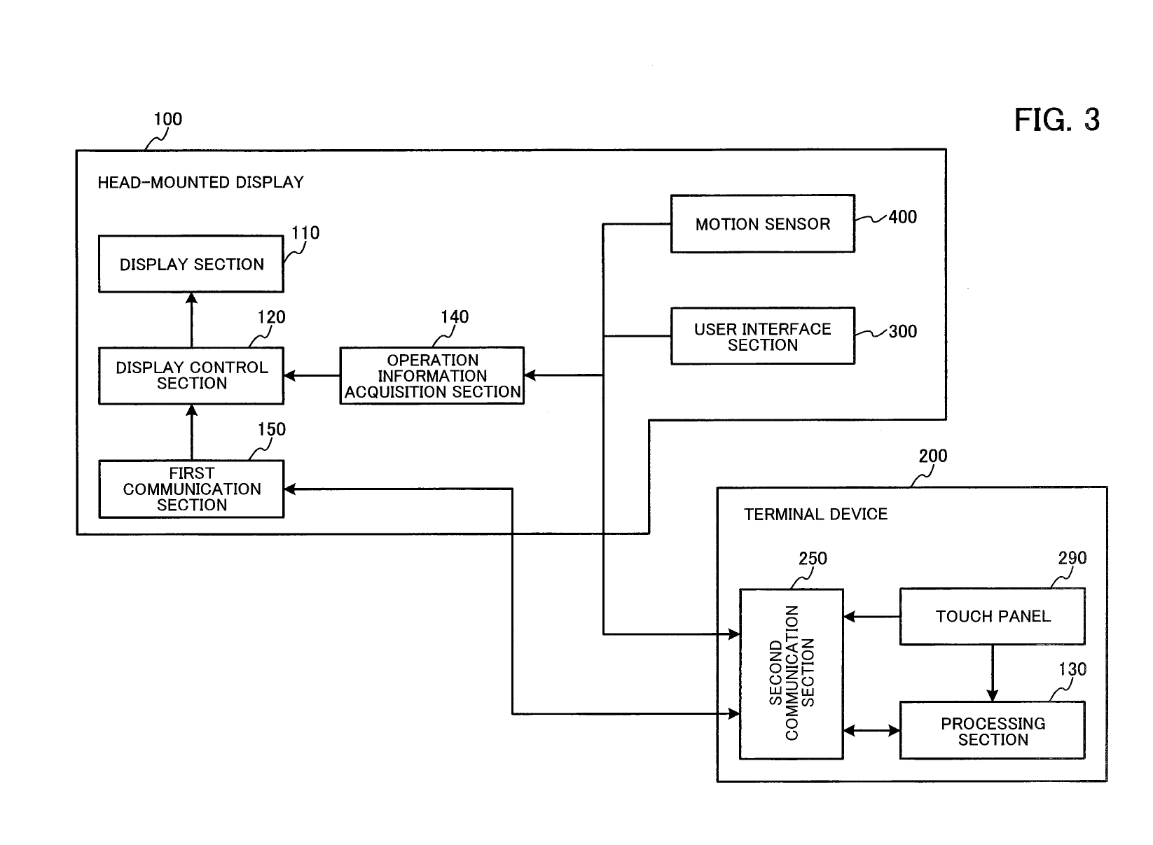

FIG. 3 illustrates a modification of the configuration of the head-mounted display as a second system configuration example according to one embodiment of the invention. The second system configuration example is mainly used when unlocking the terminal device. Note that the application of the second system configuration example is not limited thereto.

The head-mounted display 100 illustrated in FIG. 3 includes the display section 110, the display control section 120, the operation information acquisition section 140, a first communication section 150, the user interface section 300, and the motion sensor 400, and does not include the processing section 130. In this case, the processing section 130 is included in the terminal device 200 or the like. In the example illustrated in FIG. 3, the terminal device 200 includes the processing section 130, a second communication section 250, and a touch panel 290.

The terminal device 200 is a portable terminal device (electronic device) such as a smartphone or a PDA, for example. The terminal device 200 may be an electronic device such as a personal computer (PC), a digital audio player, a game device, an automatic teller machine (ATM), a vending machine, a copying machine, or a car navigation system.

The connection relationship between each section is described below. The second system configuration example illustrated in FIG. 3 differs from the first system configuration example illustrated in FIG. 2 in that the head-mounted display 100 according to the second system configuration example has a configuration in which the operation information acquisition section 140 is connected to the display control section 120, and the first communication section 150 is connected to the display control section 120. The terminal device 200 has a configuration in which the touch panel 290 is connected to the processing section 130 and the second communication section 250, and the processing section 130 is connected to the second communication section 250. The second communication section 250 is connected to the operation information acquisition section 140 and the first communication section 150 through wireless or cable communication. The connection relationship other than those described above is the same as described above with reference to FIG. 2.

The process performed by each section according to the second system configuration example is described below. Note that the process performed by the display section 110, the process performed by the display control section 120, the process performed by the user interface section 300, and the process performed by the motion sensor 400 are the same as described above with reference to FIG. 2, and description thereof is omitted.

The terminal device 200 may include part or the entirety of the processing section 130. In this case, the processing section 130 included in the terminal device 200 performs part or the entirety of the unlocking process performed by the processing section 130 included in the head-mounted display 100 according to the first system configuration example.

In the second system configuration example, the terminal device 200 includes the touch panel 290. The touch panel 290 displays the display image, and detects the user operation information. Note that the terminal device 200 need not necessarily include the touch panel 290. The terminal device 200 may include the user interface section 300 such as a keyboard, a mouse, a button, a camera, and a microphone. The terminal device 200 may include the motion sensor 400.

The first communication section 150 and the second communication section 250 exchange information using a communication standard such as Wi-Fi (registered trademark) or Bluetooth (registered trademark). Note that the first communication section 150 and the second communication section 250 may communicate through either cable communication or wireless communication. The operation information acquisition section 140 and the first communication section 150 may be an identical functional section, or may be different functional sections (see FIG. 3).

In the example illustrated in FIG. 3, the operation information acquisition section 140 receives the user operation information, and the first communication section 150 receives unlocking determination results, and transmits information relating to a selection pattern.

### 2.3 Third System Configuration Example

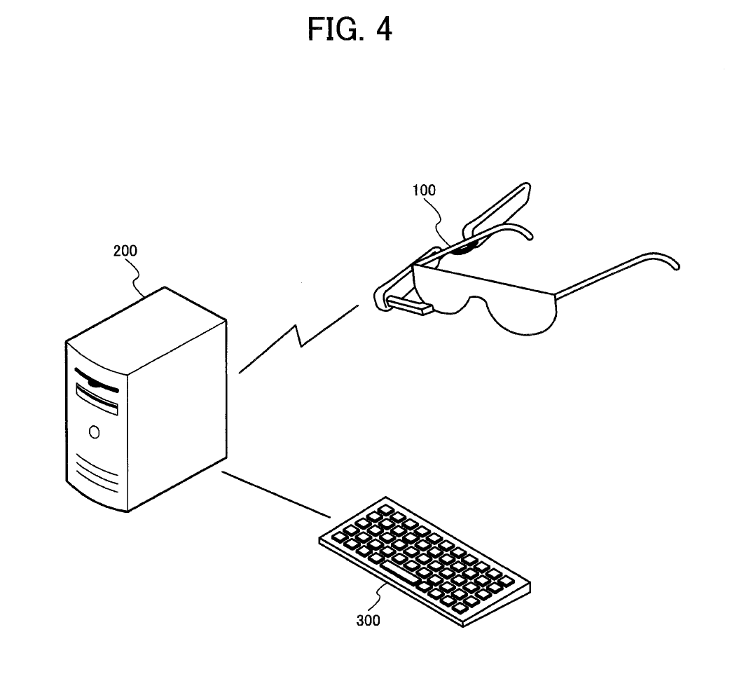

An example when unlocking the terminal device is described below. As illustrated in FIG. 4, a PC 200 is unlocked using the head-mounted display 100 that is connected to the PC 200 through wireless communication, and a keyboard (user interface section) 300 that is connected to the PC 200 through cable communication, for example. Note that the head-mounted display 100 may be unlocked in the same manner as described below.

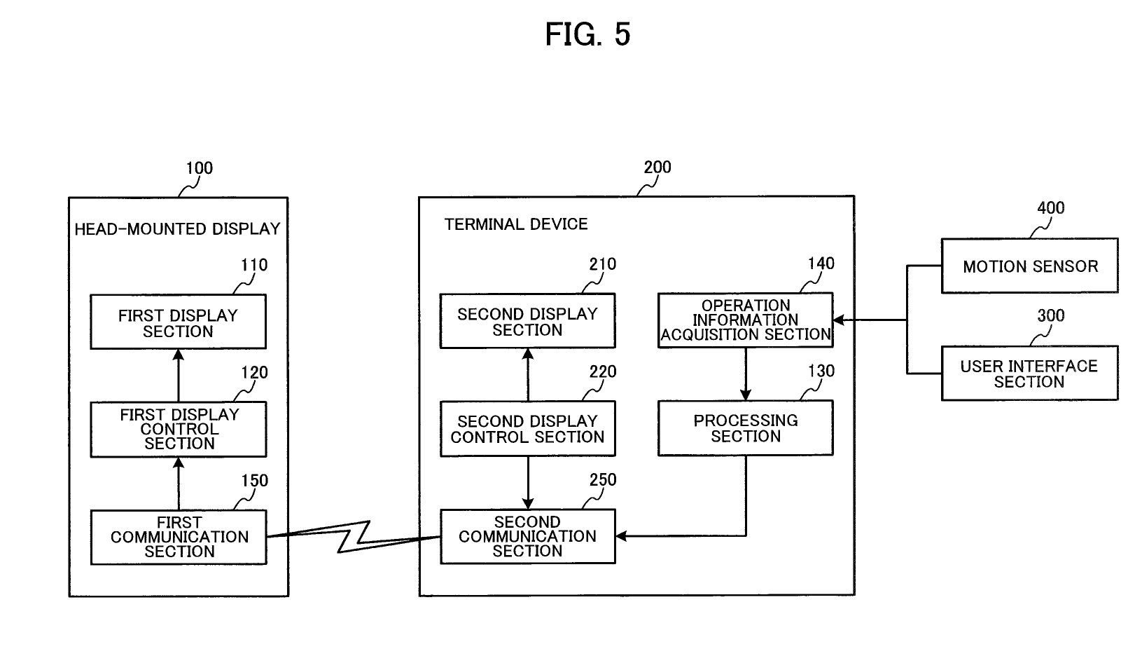

FIG. 5 illustrates a detailed configuration example of the unlocking system as a third system configuration example according to one embodiment of the invention. The unlocking system according to the third system configuration example includes the head-mounted display 100, and the terminal device 200 that is communicably connected to the head-mounted display 100.

The third system configuration example differs from the first system configuration example illustrated in FIG. 2 in that the head-mounted display 100 according to the third system configuration example includes a first display section 110 (display section 110 illustrated in FIG. 2), a first display control section 120 (display control section 120 illustrated in FIG. 2), and the first communication section 150, and does not include the processing section 130 and the operation information acquisition section 140.

The terminal device 200 includes a second display section 210, a second display control section 220, the processing section 130, the operation information acquisition section 140, and the second communication section 250. Note that the configuration of the unlocking system is not limited to the configuration illustrated in FIG. 5. Various modifications may be made, such as omitting some of the elements illustrated in FIG. 5, or adding other elements.

The connection relationship between each section is described below. The head-mounted display 100 according to the third system configuration example illustrated in FIG. 5 has a configuration in which the first communication section 150 is connected to the first display control section 120, and the first display control section 120 is connected to the first display section 110.

The terminal device 200 according to the third system configuration example has a configuration in which the user interface section 300 or the motion sensor 400 is connected to the operation information acquisition section 140, and the operation information acquisition section 140 is connected to the processing section 130. The processing section 130 is connected to the second communication section 250. The second display control section 220 is connected to the second display section 210 and the second communication section 250. The second communication section 250 and the first communication section 150 are connected through cable or wireless communication.

The process performed by each section according to the third system configuration example is described below. Note that the functions of the first display section 110, the first display control section 120, the processing section 130, the operation information acquisition section 140, the first communication section 150, the second communication section 250, the user interface section 300, and the motion sensor 400 are the same as described above with reference to FIGS. 2 and 3, and description thereof is omitted.

The second display section 210 displays the display image according to the display control process performed by the second display control section 120 in the same manner as the first display section 110. The second display section 210 may be implemented by a liquid crystal display, an organic EL display, electronic paper, or the like. The second display section 210 may be the touch panel 290 described above in connection with the second system configuration example illustrated in FIG. 3. In this case, the second display section 210 (touch panel 290) also functions as the user interface section.

The second display control section 220 performs the control process that displays the display image on the second display section 210. Note that the function of the second display control section 220 may be implemented by hardware such as a processor (e.g., CPU) or an ASIC (e.g., gate array), a program, or the like.

### 3. Method

The method according to one embodiment of the invention is described below.

The head-mounted display 100 according to one embodiment of the invention is worn on the head of the user 10, and includes the display section 110 that displays the display image, and the display control section 120 that performs the control process that displays the display image on the display section 110. The display control section 120 displays an unlocking screen on the display section 110, the unlocking screen allowing the user 10 to unlock the head-mounted display 100, or the terminal device 200 that is communicably connected to the head-mounted display 100. When the head-mounted display 100 or the terminal device 200 has been unlocked using the unlocking screen, the display control section 120 displays an unlocked state notification screen on the display section 110, the unlocked state notification screen notifying the user 10 that the head-mounted display 100 or the terminal device 200 has been unlocked.

According to one embodiment of the invention, the display control section 120 displays the unlocking screen on the display section 110 of the head-mounted display 100 when the head-mounted display 100 or the terminal device 200 is locked. This makes it possible to notify the user that the head-mounted display 100 or the terminal device 200 is locked.

There may be a case where only one of the head-mounted display 100 and the terminal device 200 is locked, or both the head-mounted display 100 and the terminal device 200 are locked.

The expression “the head-mounted display 100 is locked” used herein refers to a state in which information displayed on the display section 110 of the head-mounted display 100 is limited, a state in which operation that can be performed using the operation section (e.g., button) provided to the side or the like of the head-mounted display 100 is limited, and the like.

The expression “the terminal device 200 is locked” used herein refers to a state in which information displayed on the display section of the terminal device 200 is limited, a state in which operation that can be performed using the operation section (e.g., touch panel 290) of the terminal device 200, or the user interface section 300 (e.g., keyboard), is limited, a state in which some of the functions of the terminal device 200 cannot be used, and the like.

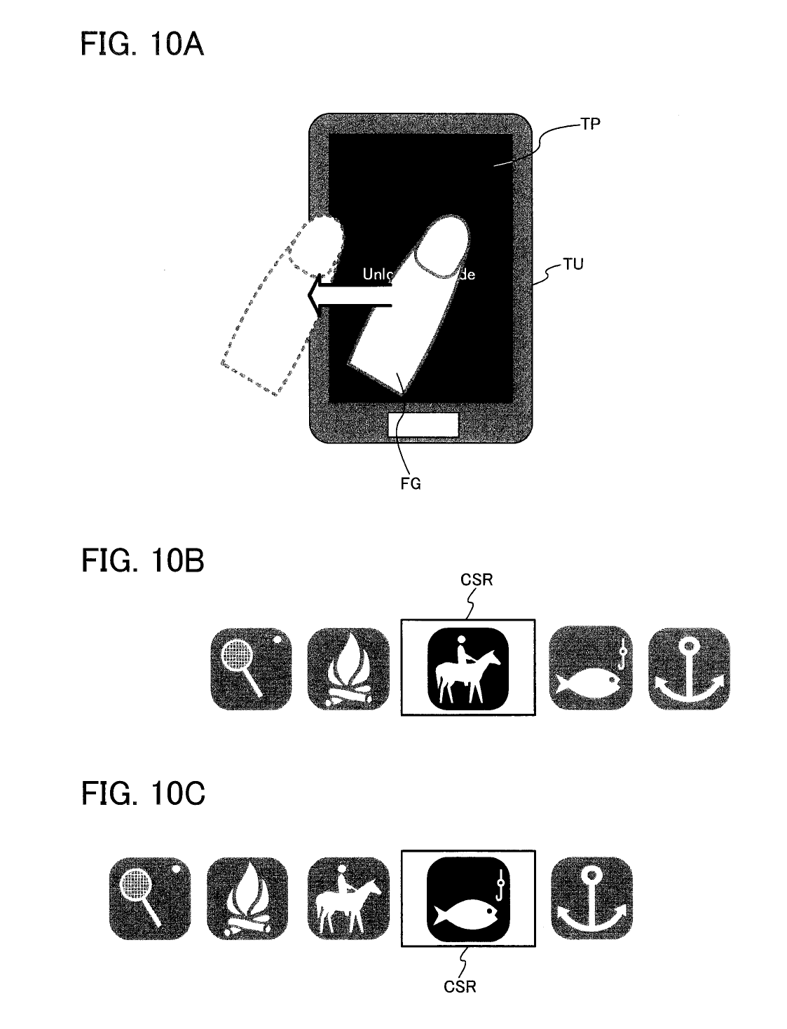

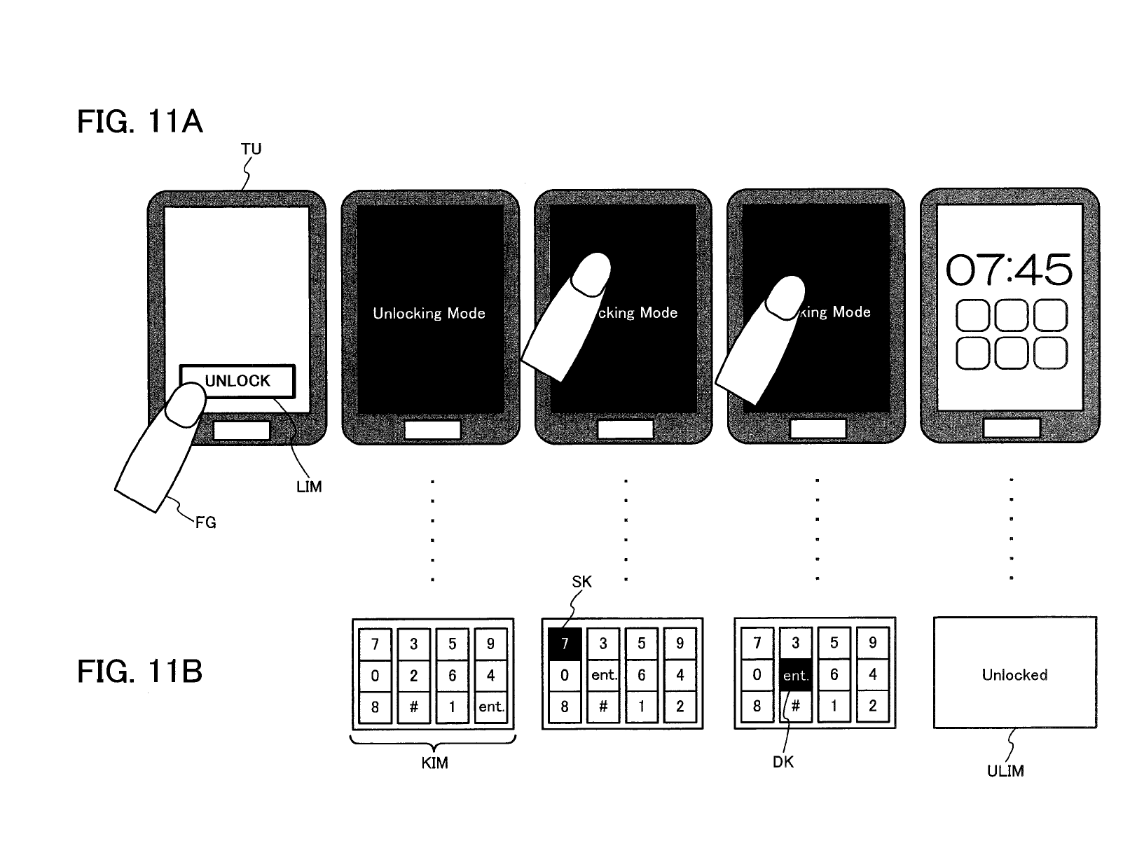

The term “unlocking screen” used herein refers to a screen that is displayed on the display section 110 of the head-mounted display 100 when the head-mounted display 100 or the terminal device 200 is locked, and allows the user 10 to unlock the head-mounted display 100 or the terminal device 200. For example, the unlocking screen is the screen illustrated in FIG. 10B (described later), the screen KIM illustrated in FIG. 11B (described later), and the like.

When the head-mounted display 100 or the terminal device 200 has been unlocked by the unlocking process described later, the display control section 120 displays the unlocked state notification screen on the display section 110. This makes it possible to notify the user that the head-mounted display 100 or the terminal device 200 has been unlocked.

The term “unlocked state notification screen” used herein refers to a screen that is displayed on the display section 110 of the head-mounted display 100 when the head-mounted display 100 or the terminal device 200 has been unlocked, and notifies the user 10 that the head-mounted display 100 or the terminal device 200 has been unlocked. The unlocked state notification screen may be a screen that explicitly notifies the user 10 that the head-mounted display 100 or the terminal device 200 has been unlocked (see the screen ULIM illustrated in FIG. 11B (described later)), or may be a normal screen (e.g., standby screen) that implicitly notifies the user 10 that the head-mounted display 100 or the terminal device 200 has been unlocked.

The unlocking screen and the unlocked state notification screen may be generated by either the head-mounted display 100 or the terminal device 200.

According to one embodiment of the invention, the unlocking screen and the unlocked state notification screen are independently displayed on the display section 110 of the head-mounted display 100. In this case, it is desirable to display at least one of the unlocking screen and the unlocked state notification screen only on the display section 110 of the head-mounted display 100 without displaying the unlocking screen and the unlocked state notification screen on the display section of the terminal device 200.

The display image displayed on the display section 110 of the head-mounted display 100 is not easily observed by a person other than the user as compared with the display section of the terminal device 200, for example. When the display section 110 is a liquid crystal display, an organic EL display, or the like, the display section 110 is normally configured so that the information displayed on the display section 110 cannot be observed by a person other than the user.

Therefore, it is possible to prevent a situation in which a person other than the user can easily steal a glance at the information that is input by the user when the user unlocks the head-mounted display 100 or the terminal device 200. This makes it possible to prevent a situation in which a person other than the user steals the unlocking password or the like.

The head-mounted display 100 according to one embodiment of the invention may include the operation information acquisition section 140 that acquires the user operation information, and the processing section 130 that determines whether or not the head-mounted display 100 or the terminal device 200 has been unlocked based on the user operation information that has been input using the unlocking screen.

The term “user operation information” used herein refers to information that represents the operation that has been performed by the user in order to unlock the head-mounted display 100 or the terminal device 200. Specific examples of the user operation information are described in detail later.

This makes it possible for the user to unlock the head-mounted display 100 using only the head-mounted display 100, for example. In this case, since it is unnecessary to use a device other than the head-mounted display 100, the user can easily unlock the head-mounted display 100.

The terminal device 200 may include the processing section 130 (see the second system configuration example and the third system configuration example).

In this case, since the terminal device 200 can perform the unlocking determination process when unlocking the terminal device 200, for example, it is unnecessary to cause another device to perform the unlocking determination process. Therefore, when unlocking the terminal device 200, it is desirable to use the head-mounted display 100 and the unlocking system according to the second system configuration example or the third system configuration example.

In this case, since the unlocking screen and the unlocked state notification screen are displayed on the display section 110 of the head-mounted display 100, it is possible to prevent a situation in which a person other than the user can easily steal a glance at the information that is input by the user when the user unlocks the terminal device 200.

When the processing section 130 is included in the terminal device 200, it is desirable to encode the information that is exchanged between the head-mounted display 100 and the terminal device 200, and cause the head-mounted display 100 and the terminal device 200 to exchange the encoded information. This aims at preventing a situation in which the transmitted information is stolen by a person other than the user, and the password leaks, for example.

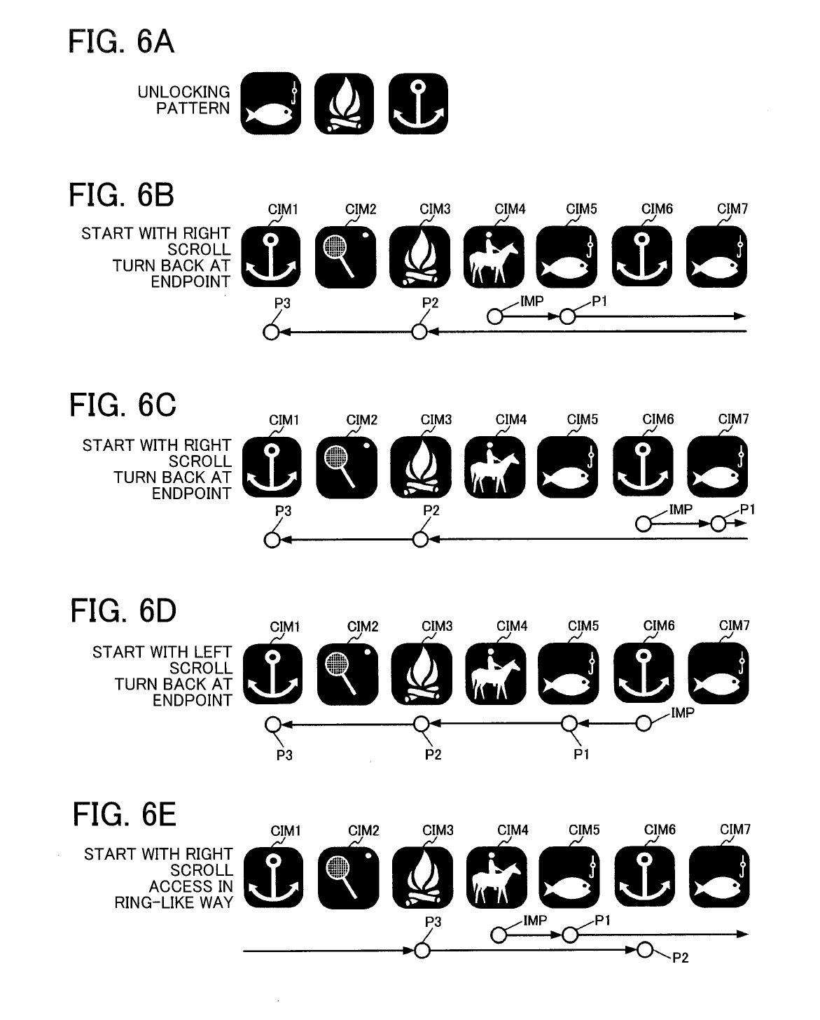

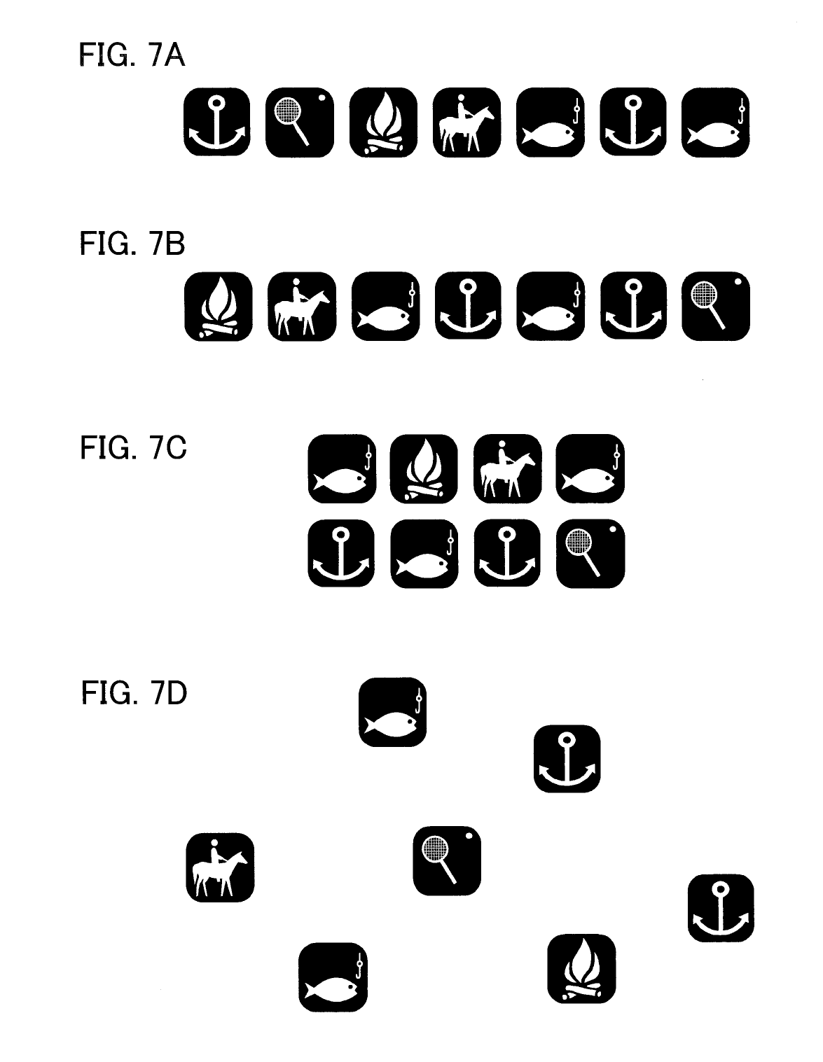

Specific examples of the unlocking screen according to one embodiment of the invention are described below with reference to FIGS. 6A to 6E and 7A to 7D.

The display control section 120 may display the unlocking screen in which a plurality of optional images are arranged, on the display section 110. The processing section 130 may specify an optional image that has been selected from among the plurality of optional images arranged within the unlocking screen based on the acquired user operation information, determine whether or not a selection pattern of the optional image selected by the user 10 coincides with an unlocking pattern, and determine that the head-mounted display 100 has been unlocked when it has been determined that the selection pattern coincides with the unlocking pattern.

The term “optional image” used herein refers to an image that represents a candidate for information that is input for unlocking the head-mounted display 100. The optional image is an icon image, a character (character string), a numeral, a symbol, a figure, or the like. The optional images are arranged within the unlocking screen, and displayed on the display section 110.

Specifically, the display control section 120 may display the unlocking screen in which a plurality of optional images are arranged, on the display section 110, the plurality of optional images being a combination of at least one of an icon image, a character, a numeral, a symbol, and a figure.

In the examples illustrated in FIGS. 6B to 6E, the optional images are icon images, and represent an anchor (image CIM1), a tennis racket (image CIM2), a fire (image CIM3), horse riding (image CIM4), a fish (image CIM5), an anchor (image CIM6), and a fish (image CIM7) (from left to right). Note that the unlocking screen may include identical optional images (i.e., the optional images that represent an anchor, and the optional images that represent a fish in the examples illustrated in FIGS. 6B to 6E).

The optional image may be referred to as a selection range that is set within the unlocking screen. For example, when the numeric keypad screen KIM illustrated in FIG. 11B is displayed as the unlocking screen, each key (e.g., numeric key and symbol key) included within the numeric keypad screen KIM corresponds to the selection range (optional image).

It is determined that the head-mounted display 100 has been unlocked when it has been determined that the selection pattern of the optional images selected by the user 10 coincides with the unlocking pattern.

The term “selection pattern” used herein refers to a combination of the selected optional images and the order of selection. FIG. 6B illustrates an example in which the optional image CIM4 (“horse riding”) is set to an initial selected state, and the optional image CIM5 (“fish”), the optional image CIM3 (“fire”), and the optional image CIM1 (“anchor”) are sequentially set to the selected state (and selection is settled). In this case, the selection pattern is “fish→fire→anchor”.

The term “unlocking pattern” is a combination of the optional images and the order of selection. It is determined to unlock the head-mounted display 100 when the selection pattern of the optional images selected by the user 10 coincides with the unlocking pattern. The unlocking pattern is a correct answer pattern that unlocks the head-mounted display 100.

FIG. 6A illustrates the unlocking pattern that corresponds to the examples illustrated in FIGS. 6B to 6E. As illustrated in FIG. 6A, the unlocking pattern is “fish→fire→anchor”. Since the selection pattern illustrated in FIG. 6B coincides with the unlocking pattern, the processing section 130 determines to unlock the head-mounted display 100.

Specifically, the user can unlock the head-mounted display 100 by settling to select the optional images displayed on the display section 110 of the head-mounted display 100 in the same order as that of the unlocking pattern. Note that the difference in selection method between FIG. 6B and FIGS. 6C to 6E is described in detail later.

In the examples illustrated in FIGS. 6B to 6E in which two images that represent a fish and two images that represent an anchor are arranged within the unlocking screen, the user may select either of the two images that represent a fish, and select either of the two images that represent an anchor. For example, the user may settle to select the optional image CIM5 as an image that represents a fish in the example illustrated in FIG. 6C instead of the optional image CIM7.

The difference in selection operation between the case of selecting the optional image CIM7 as an image that represents a fish, and the case of selecting the optional image CIM5 as an image that represents a fish in the example illustrated in FIG. 6C, is described below.

When selecting the optional image CIM7 as an image that represents a fish (i.e., when sequentially settling to select the optional images CIM7, CIM3, and CIM1), the selection position is moved to the right by one image, moved to the left by four images, and then moved to the left by two images.

When selecting the optional image CIM5 as an image that represents a fish (i.e., when sequentially settling to select the optional images CIM5, CIM3, and CIM1), the selection position is moved to the left by one image, moved to the left by two images, and then moved to the left by two images.

Specifically, when a plurality of identical optional images are arranged within the unlocking screen, the user can change the selection operation even when inputting an identical unlocking pattern, for example. This makes it possible to prevent a situation in which a person other than the user can easily guess the unlocking pattern, for example.

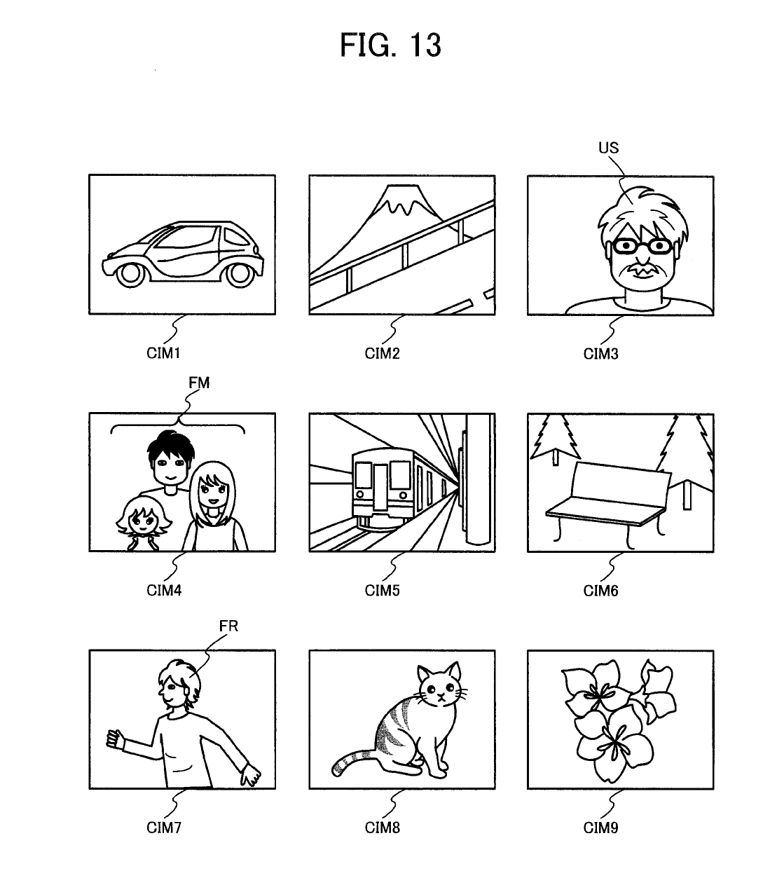

The optional images and the unlocking pattern are not limited to the examples illustrated in FIGS. 6A to 6E. For example, the optional images may include an image that represents the user's family or friend (i.e., an image that relates to the user), and an image that does not relate to the user (see FIG. 13). In this case, the unlocking pattern may be a combination of the optional images that relate to the user.

In the example illustrated in FIG. 13, images CIM1 to CIM9 are displayed as the optional images, and the image CIM3 that represents the user US, the image CIM4 that represents the user's family FM, and the image CIM7 that represents the user's friend, are images that relate to the user. The remaining images CIM1, CIM2, CIM5, CIM6, CIM5, and CIM9 are images that do not relate to the user. In this case, the unlocking pattern is set to a pattern consisting of the images CIM3, CIM4, and CIM7 (in a random order).

This makes it possible for the user to determine whether or not each image relates to the user (e.g., whether or not each image represents the user's family or friend), and input the unlocking pattern even when the user has forgotten the unlocking pattern, for example.

Although FIG. 13 illustrates an example in which the images that do not relate to the user represent an object other than a person, the images that do not relate to the user may be images that represent a person who does not have a relationship with the user. When all of the optional images represent a person, it is difficult for a person other than the user who has stolen a glance at the optional images to determine an image that relates to the user, for example.

When the user unlocks the head-mounted display 100 in a state in which a person other than the user cannot observe the information displayed on the display section 110 of the head-mounted display 100, a person other than the user may steal a glance at the operation performed by the user, and guess the input information from the operation performed by the user.

In order to prevent such a situation, the display control section 120 may display the unlocking screen in which a plurality of optional images are arranged in one row or one column, or the unlocking screen in which a plurality of optional images are arranged in a two-dimensional array having i rows and j columns (i and j are positive integers, provided that at least one of i and j is equal to or larger than 2), on the display section 110.

When using the unlocking screen in which a plurality of optional images are arranged in one row (see FIGS. 6B to 6E), the user can sequentially set the optional images to a selected state from right to left, or from left to right, for example.

Likewise, when using the unlocking screen in which a plurality of optional images are arranged in one column, the user can sequentially set the optional images to a selected state downward or upward, for example.

Since the user sequentially set the optional images to a selected state by performing an identical operation when using the unlocking screen in which a plurality of optional images are arranged in one row or one column, it is more difficult for a person other than the user to decipher the input information, for example. Specifically, it is difficult for a person other than the user to determine the optional images that have been set to a selected state, and for which selection has been settled by the user, for example.

FIG. 7C illustrates an example of the unlocking screen in which a plurality of optional images are arranged in a two-dimensional array having two rows and four columns.

When using the unlocking screen in which a plurality of optional images are arranged in such a two-dimensional array, the user can select the optional images in four directions (upward, downward, rightward, and leftward), for example. This makes it more difficult for a person other than the user to decipher the input information, for example.

The display control section 120 may display the unlocking screen in which a plurality of optional images are arranged at random positions, on the display section 110.

For example, the display control section 120 may display the unlocking screen illustrated in FIG. 7D in which a plurality of optional images are arranged at random positions.

This makes it more difficult for a person other than the user to decipher the input information, for example.

The display control section 120 may display a first unlocking screen on the display section 110 as the unlocking screen at a first display timing, and display a second unlocking screen on the display section 110 as the unlocking screen at a second display timing that differs from the first display timing, the second unlocking screen differing from the first unlocking screen as to the arrangement positions of the plurality of optional images.

For example, the first unlocking screen in which a plurality of optional images are arranged as illustrated in FIG. 7A is displayed at the first display timing, and the second unlocking screen in which a plurality of optional images are arranged as illustrated in FIG. 7B is displayed at the second display timing.

The display control section 120 may display the unlocking screen in which the arrangement positions of a plurality of optional images are periodically changed, on the display section 110.

When the arrangement positions of a plurality of optional images are changed every timing, a different optional image is set to the selected state even when the user has performed an identical operation. This makes it more difficult for a person other than the user to decipher the input information, for example.

The processing section 130 may set an optional image among the plurality of optional images to the initial selected state at the initial selection timing. The display control section 120 may display the unlocking screen in which at least the optional image that has been set to the initial selected state is arranged, on the display section 110.

The term “initial selected state” used herein refers to a selected state that is automatically set at the initial selection timing independently of the user operation information. In the example illustrated in FIG. 6B, the optional image CIM4 is set to the initial selected state.

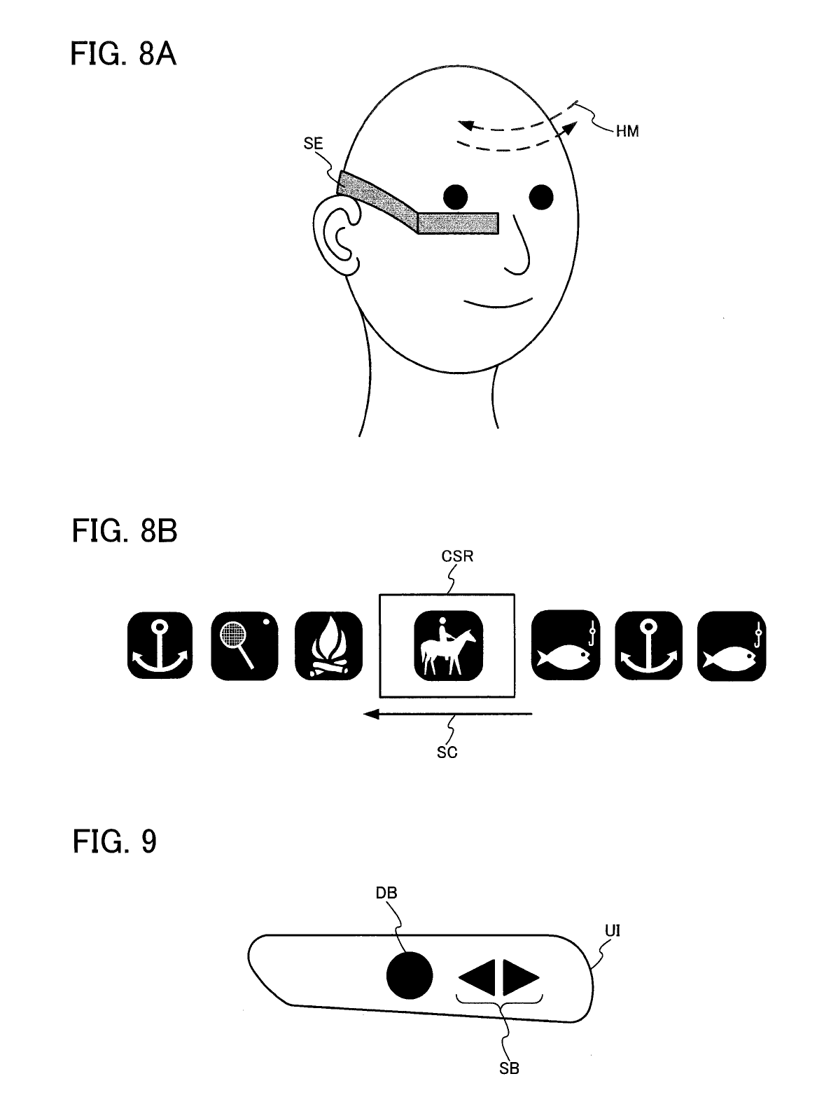

The term “selected state” used herein refers to a state in which an optional image has been selected as information that is input for unlocking the head-mounted display 100. For example, when one optional image has been set to the selected state, the optional image that has been set to the selected state may be displayed so that the cursor image CSR illustrated in FIG. 8B is superimposed on the optional image, or displayed to be larger than other optional images that are not set to the selected state, or differ in color from other optional images that are not set to the selected state. Alternatively, when one optional image has been set to the selected state, only the optional image that has been set to the selected state may be displayed within the unlocking screen (i.e., only the optional image that has been set to the selected state may be displayed within one screen). Note that it suffices that the optional image that has been set to the selected state be displayed so that the user can distinguish the optional image that has been set to the selected state from other optional images that are not set to the selected state. Note that it is necessary to settle to select the optional image that has been set to the selected state in order to unlock the head-mounted display 100. The selection pattern is determined when the user has settled to select the optional image that has been set to the selected state.

The term “initial selection timing” used herein refers to the start timing of the unlocking process, or the arrangement position change timing when periodically changing the arrangement positions of the plurality of optional images, for example. This makes it possible to automatically set an optional image among the plurality of optional images to the selected state at the start timing of the unlocking process, for example. This makes it unnecessary for the user to set an arbitrary optional image to the selected state when no optional image is selected.

The processing section 130 may set the kth optional image among the first to Nth optional images to the initial selected state at a first initial selection timing (N is a positive integer, and k is an integer that satisfies 1≦k≦N), and set the mth optional image among the first to Nth optional images to the initial selected state at a second initial selection timing that differs from the first initial selection timing (m is an integer that satisfies 1≦m≦N and k≠m).

For example, when FIG. 6B corresponds to the first initial selection timing, and FIG. 6C corresponds to the second initial selection timing, the optional image CIM4 is set to the initial selected state at the first initial selection timing, and the optional image CIM6 that differs from the optional image CIM4 is set to the initial selected state at the second initial selection timing.

When the optional image that is set to the initial selected state is changed every timing, a different optional image is set to the selected state even when the user has performed an identical operation, for example.

More specifically, when the user has set the optional image situated on the immediate left side of the initial selection position IMP to the selected state immediately after the start of the unlocking process in FIG. 6B, the icon image (optional image) CIM3 that represents a fire is set to the selected state. On the other hand, when the user has set the optional image situated on the immediate left side of the initial selection position IMP to the selected state immediately after the start of the unlocking process in FIG. 6C, the icon image (optional image) CIM5 that represents a fish is set to the selected state.

In this case, a different optional image is set to the selected state although the user has performed an identical operation that sets the optional image situated on the immediate left side of the initial selection position to the selected state. This makes it more difficult for a person other than the user to decipher the input information since it is observed that the user is performing an identical operation, for example.

An identical optional image may be set to the selected state in FIGS. 6B and 6C when the user has performed an identical operation. For example, when the user has set the optional image situated at the position P1 on the immediate right side of the initial selection position IMP to the selected state immediately after the start of the unlocking process in FIG. 6B, the icon image (optional image) CIM5 that represents a fish is set to the selected state. When the user has set the optional image situated at the position P1 on the immediate right side of the initial selection position IMP to the selected state immediately after the start of the unlocking process in FIG. 6C, the icon image (optional image) CIM7 that represents a fish is set to the selected state. In this case, an identical optional image is merely selected for the reason that the icon image that represents a fish is situated on the immediate right side of the initial selection position in FIGS. 6B and 6C.

In the example illustrated in FIG. 6B, the user must move the selection position to the right by two images, and then move the selection position to the left by four images when the user selects the next optional image (icon image that represents a fire) that corresponds to the unlocking pattern after settling to select the icon image that represents a fish. In the example illustrated in FIG. 6C, the user can select the icon image that represents a fire by merely moving the selection position to the left by four images.

Specifically, it is possible to change the operation required to select an identical optional image by changing the initial selection position, for example.

The processing section 130 may specify a selection direction based on the user operation information, the selection direction representing a direction in which the optional image that is to be set to the selected state is situated within the unlocking screen with respect to the optional image that has been set to the selected state.

In the example illustrated in FIG. 6B, the optional image CIM4 situated at the initial selection position IMP is set to the initial selected state. The processing section 130 determines based on the user operation information whether to set the optional image CIM5 situated at the position P1 on the right side of the initial selection position IMP to the selected state, or set the optional image CIM3 situated at the position P2 on the left side of the initial selection position IMP to the selected state.

The selection direction is the rightward direction when setting the optional image CIM5 situated at the position P1 on the right side of the initial selection position IMP to the selected state, and is the leftward direction when setting the optional image CIM3 situated at the position P2 on the left side of the initial selection position IMP to the selected state. In FIG. 6B, the selection direction is determined to be the rightward direction.

This makes it possible to change the selection direction even when the user has performed an identical operation, for example.

Specifically, when the user operation information has been acquired by the operation information acquisition section 140 when the rth optional image among the first to Nth optional images has been set to the selected state (N is a positive integer, and r is an integer that satisfies 1≦r≦N), the processing section 130 may set the selection direction to a first direction at a first selection timing, set the sth optional image that is situated in the first direction with respect to the rth optional image within the unlocking screen to the selected state (s is an integer that satisfies 1≦s≦N and r≠s), set the selection direction to a second direction that differs from the first direction at a second selection timing that differs from the first selection timing, and set the tth optional image that is situated in the second direction with respect to the rth optional image within the unlocking screen to the selected state (t is an integer that satisfies 1≦t≦N and r≠t). A specific example of such a situation is described below with reference to FIGS. 6C and 6D. In FIGS. 6C and 6D, the sixth optional image CIM6 among the first optional image CIM1 to the seventh optional image CIM7 is set to the selected state immediately after the start of the unlocking process (N=7, r=6).

The operation information acquisition section 140 then acquires the user operation information.

In this case, the selection direction is set to the rightward direction (first direction) at the first selection timing (FIG. 6C). The seventh optional image CIM7 that is situated in the rightward direction with respect to the sixth optional image CIM6 within the unlocking screen is set to the selected state (s=7).

The selection direction is set to the leftward direction (second direction) at the second selection timing (FIG. 6D), and the fifth optional image CIM5 that is situated in the leftward direction with respect to the sixth optional image CIM6 within the unlocking screen is set to the selected state (t=5).

Specifically, when the selection direction is set to a different direction every timing, a different optional image is set to the selected state even when the user has performed an identical operation. This makes it more difficult for a person other than the user to decipher the input information, for example.

Note that it is possible to allow the user to select the optional images so that the selection position is turned back at the endpoint of the unlocking screen (see FIGS. 6B and 6C), or allow the user to select the optional images so that, when one endpoint of the unlocking screen has been reached, the selection position moves to the other endpoint (see FIG. 6E).

A specific example of the user operation information is described below.

The operation information acquisition section 140 may acquire the motion sensor signal from the motion sensor 400 as the user operation information.

The motion sensor signal refers to a signal that is acquired from the motion sensor 400 by the operation information acquisition section 140. The motion sensor signal may be an acceleration sensor signal, a gyro sensor signal, or a direction sensor signal, for example.

This makes it possible to set an optional image among the plurality of optional images to the selected state corresponding to the motion of the body of the user, for example.

The operation information acquisition section 140 may acquire the motion sensor signal that represents the motion of the head of the user 10 from the motion sensor 400. The processing section 130 may specify the motion of the head of the user 10 based on the motion sensor signal, and specify a selection direction based on the motion of the head of the user 10, the selection direction representing a direction in which the optional image that is to be set to the selected state is situated within the unlocking screen with respect to the optional image that has been set to the selected state.

For example, the motion HM of the head of the user is specified based on a motion sensor signal acquired from a motion sensor SE (see FIG. 8A). When it has been determined that the head of the user has moved in the leftward direction, the cursor image CSR that indicates an optional image among a plurality of optional images that has been set to the selected state is moved in the leftward direction SC (see FIG. 8B). Note that the cursor image may be moved in the rightward direction when it has been determined that the head of the user has moved in the leftward direction, for example.

This makes it possible to set an optional image among the plurality of optional images to the selected state corresponding to the motion of the head of the user, for example.

The operation information acquisition section 140 may acquire the user operation information from the user interface section 300 that includes a selection operation section for performing a selection operation, and a selection settlement operation section for performing a selection settlement operation. The processing section 130 may set the optional image that has been set to the selected state to a non-selected state, and set another optional image to the selected state when it has been detected that the selection operation section has been operated based on the user operation information, and settle that the optional image that has been set to the selected state is selected when it has been detected that the selection settlement operation section has been operated based on the user operation information.

The processing section 130 may perform the unlocking determination process on the selection pattern that has been input when it has been detected that the selection settlement operation section has been continuously operated twice.

FIG. 9 illustrates an example of the user interface section 300 (UI). The user interface section UI illustrated in FIG. 9 is attached to the side of the head-mounted display 100, and includes a selection operation section SB and a selection settlement operation section DB. FIG. 9 illustrates an example in which the selection operation section SB and the selection settlement operation section DB are implemented by a push button.

The selection operation section SB is used to change the optional image that is set to the selected state by moving a cursor image (see FIG. 8B), for example. The selection settlement operation section DB is used to settle to select the optional image that has been set to the selected state. When the user interface section 300 is implemented by a keyboard, the arrow keys may be used as the selection operation section, and the enter key may be used as the selection settlement operation section, for example. Note that another key may be used as the selection operation section and the selection settlement operation section.

This makes it possible to set an optional image among the plurality of optional images to the selected state corresponding to the operation performed by the user using the user interface section 300, for example.

The operation information acquisition section 140 may acquire the user operation information from the terminal device 200 that includes the touch panel 290 that displays the display image, and detects the user operation information.

This makes it possible to set an optional image among the plurality of optional images to the selected state corresponding to the operation performed by the user using the touch panel 290, for example.

The processing section 130 may set the optional image that has been set to the selected state to a non-selected state, and set another optional image to the selected state when it has been detected that a flick has been performed on the touch panel 290 based on the user operation information.

As illustrated in FIG. 10A, an optional image among a plurality of optional images displayed within the unlocking screen is selected by performing a flick on a touch panel TP of a terminal device TU with a finger FG, for example. In the examples illustrated in FIGS. 10A to 10C, it is detected that a flick has been performed with the finger FG in the leftward direction (FIG. 10A), the cursor image CSR is moved in the rightward direction (FIG. 10B), the optional image that represents horse riding is set to a non-selected state from the selected state, and the optional image that represents a fish is set to the selected state from a non-selected state (FIG. 10C). Note that the arrangement positions of the optional images may be shifted in the transverse direction without moving the cursor image CSR to set the optional image situated within the cursor image CSR (i.e., the optional image that has been moved to a position at which the cursor image CSR is superimposed on the optional image) to the selected state. In the examples illustrated in FIGS. 10B and 10C, only the black optional image that has been set to the selected state may be displayed within the unlocking screen, and the gray optional images may not be displayed within the unlocking screen.

The processing section 130 may settle that the optional image that has been set to the selected state is selected when it has been detected that a tap has been performed on the touch panel 290 based on the user operation information. The tap operation may be a single tap or a double tap.

The term “flick” used herein refers to a slide motion performed on the surface of a touch panel (or a motion that quickly moves a finger to trace the surface of a touch panel). The term “tap” used herein refers to a motion that presses the surface of a touch panel (or a motion that places a finger on the surface of a touch panel for a specific period). A motion that taps only once is referred to as “single tap”, and a motion that successively taps twice is referred to as “double tap”.

This makes it possible for the user to change the optional image that is set to the selected state by performing an intuitive flick operation, and settle to select the optional image that has been set to the selected state by performing an intuitive tap operation, for example.

The processing section 130 may set the optional image that has been set to the selected state to a non-selected state, and set another optional image to the selected state when it has been detected that a single tap has been performed on the touch panel 290 based on the user operation information, and settle that the optional image that has been set to the selected state is selected when it has been detected that a double tap has been performed on the touch panel 290 based on the user operation information.

In this case, the selection direction may be always set to a given direction. For example, the cursor image may be necessarily moved in the rightward direction when a single tap has been performed.

This makes it possible for the user to perform the selection operation and the selection select operation by changing the number of taps performed on the touch panel 290, for example.

The operation of the unlocking system according to the third system configuration example illustrated in FIG. 5 is described below.

The unlocking system according to the third system configuration example illustrated in FIG. 5 includes the head-mounted display 100, and the terminal device 200 that is communicably connected to the head-mounted display 100. The head-mounted display 100 includes the first display section 110 that displays a first display image, and the first display control section 120 that performs the control process that displays the first display image on the first display section 110. The terminal device 200 includes the second display section 210 that displays a second display image, and the second display control section 220 that performs the control process that displays the second display image on the second display section 210. The head-mounted display 100 or the terminal device 200 includes the processing section 130 that performs the unlocking determination process, and the operation information acquisition section 140 that acquires the user operation information.

The first display control section 120 displays the unlocking screen for unlocking the head-mounted display 100 or the terminal device 200 on the first display section 110. The processing section 130 determines whether or not the head-mounted display 100 or the terminal device 200 has been unlocked based on the user operation information that has been input using the unlocking screen. The first display control section 120 displays the unlocked state notification screen on the first display section 110 when it has been determined that the head-mounted display 100 or the terminal device 200 has been unlocked, the unlocked state notification screen notifying that the head-mounted display 100 or the terminal device 200 has been unlocked.

The first display control section 120 may display the unlocking screen on the first display section 110 during the unlocking process. The second display control section 220 may set the second display section 210 to a non-display state during the unlocking process, and set the second display section 210 to a display state when the processing section 130 has determined that the head-mounted display 100 or the terminal device 200 has been unlocked.

FIGS. 11A and 11B illustrate a specific example of the operation of the unlocking system. FIG. 11A illustrates the operation performed on the terminal device TU (sequentially from the right), and FIG. 11B illustrates the display image displayed on the first display section 110 of the head-mounted display 100 corresponding to each operation illustrated in FIG. 11A.

When the user has performed a tap with the finger FG on an unlocking process start image LIM within the unlocking screen, the unlocking process starts. The second display section 210 of the terminal device TU is then set to a non-display state. This makes it impossible for a person other than the user to observe the information input by the user.

The unlocking screen KIM is displayed on the first display section 110 of the head-mounted display 100. Therefore, a person other than the user cannot observe the unlocking screen and the information input by the user (i.e., only the user can observe the unlocking screen and the information input by the user). Note that the unlocking screen KIM displayed in the example illustrated in FIG. 11B is a numeric keypad image, and each numeric character key SK within the numeric keypad image corresponds to the selection range (optional image).

When the user has selected a plurality of numeric character keys, and selected the enter key DK, the processing section performs the unlocking determination process. When it has been determined that the selection pattern coincides with the unlocking pattern, the processing section 130 unlocks the head-mounted display 100 or the terminal device 200, and the unlocked state notification screen ULIM is displayed on the first display section 110 of the head-mounted display 100.

This makes it possible to prevent a situation in which a person other than the user steals a glance at the display section 210 of the terminal device 200, and the unlocking password leaks, for example.

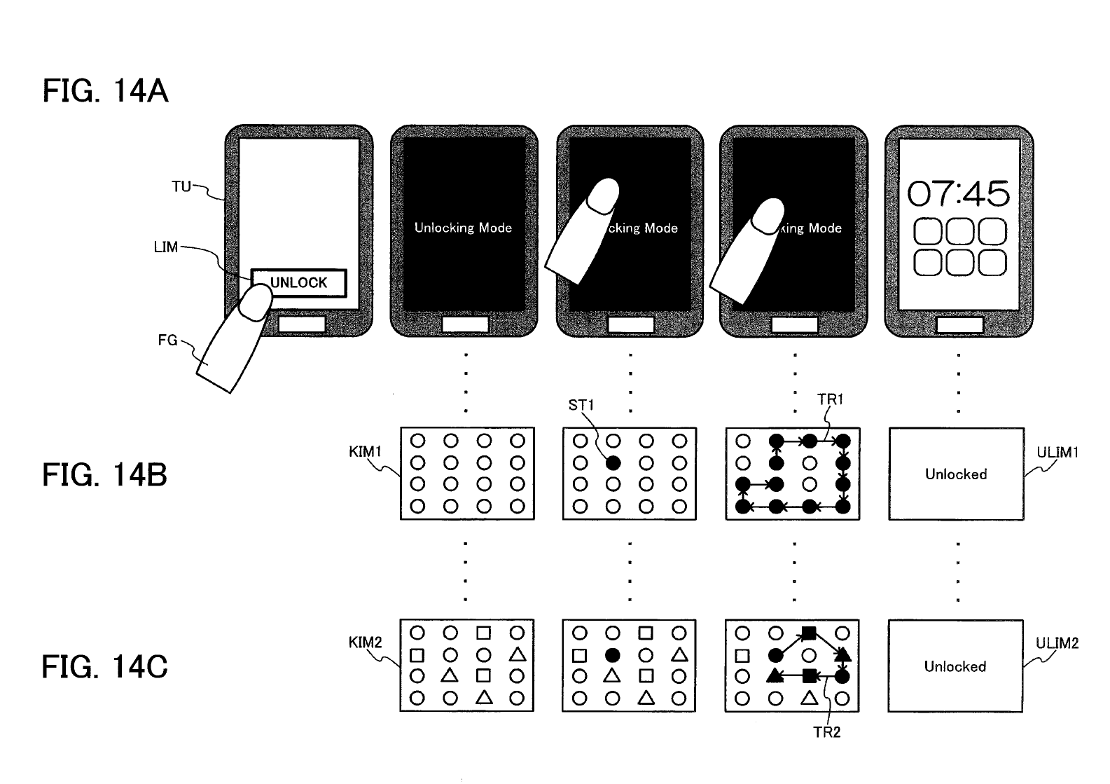

A method that performs the unlocking process based on the order of selection ranges that have been traced with a finger is described below with reference to FIGS. 14A to 14C. FIG. 14A illustrates the operation performed on the terminal device TU (sequentially from the right), and FIG. 14B illustrates the display image displayed on the first display section 110 of the head-mounted display 100 corresponding to each operation illustrated in FIG. 14A. FIG. 14C illustrates the display image during the unlocking process that differs from the display image illustrated in FIG. 14B.

The example illustrated in FIG. 14B is described below. As illustrated in FIG. 14A, when the user has performed a tap with the finger FG on the unlocking process start image LIM within the unlocking screen, the unlocking process starts. The second display section 210 of the terminal device TU is then set to a non-display state.

An unlocking screen KIM1 is displayed on the first display section 110 of the head-mounted display 100. In the example illustrated in FIG. 14B, a plurality of circular selection ranges are set within the unlocking screen KIM1.

The user sequentially traces the desired circular selection ranges with the finger. In the example illustrated in FIG. 14B, the user places the finger within the selection range ST1, and traces the desired selection ranges so as to draw a path indicated by TR1. When it has been determined that the order TR1 of the traced selection ranges (selection pattern) coincides with the unlocking pattern set in advance, the processing section 130 unlocks the head-mounted display 100 or the terminal device 200, and an unlocked state notification screen ULIM1 is displayed on the first display section 110 of the head-mounted display 100. In the example illustrated in FIG. 14B, whether or not the selection pattern coincides with the unlocking pattern is determined based on whether or not the positions and the order of the traced selection ranges coincides with the unlocking pattern.

In the example illustrated in FIG. 14C, circular selection ranges, triangular selection ranges, and square selection ranges are set within the unlocking screen. Note that the shape of the selection range is not limited to a circle, a triangle, a square, and the like. The selection range may have an arbitrary shape.

In this case, the unlocking pattern is set to “circle→square→triangle→circle→square→triangle”, for example. Whether or not the selection ranges traced by the user (TR2 in FIG. 14C) coincide with the unlocking pattern is determined. When it has been determined that the selection ranges traced by the user coincide with the unlocking pattern, the processing section 130 unlocks the head-mounted display 100 or the terminal device 200, and an unlocked state notification screen ULIM2 is displayed on the first display section 110. Note that the selection range set at an arbitrary position may be selected as long as the selection range has an identical shape. Specifically, the user may trace a different path with the finger corresponding to an identical unlocking pattern.

This makes it more difficult for a person other than the user to decipher the unlocking pattern, for example.

Note that part or most of the processes performed by the head-mounted display 100, the unlocking system, and the like according to the embodiments of the invention may be implemented by a program. In this case, the head-mounted display 100, the unlocking system, and the like are implemented by causing a processor (e.g., CPU) to execute a program. Specifically, a program stored in an information storage device is read, and executed by a processor (e.g., CPU). The information storage device (computer-readable device) stores a program, data, and the like. The function of the information storage device may be implemented by an optical disk (e.g., DVD or CD), a hard disk drive (HDD), a memory (e.g., memory card or ROM), or the like. The processor (e.g., CPU) performs various processes according to the embodiments of the invention based on the program (data) stored in the information storage device. Specifically, a program that causes a computer (i.e., a device that includes an operation section, a processing section, a storage section, and an output section) to function as each section according to the embodiments of the invention (i.e., a program that causes a computer to execute the process implemented by each section) is stored in the information storage device.

The head-mounted display 100, the unlocking system, and the like according to the embodiments of the invention may include a processor and a memory. The processor may be a central processing unit (CPU), for example. Note that the processor is not limited to a CPU. Various types of processors such as a graphics processing unit (GPU) and a digital signal processor (DSP) may also be used. The processor may be a hardware circuit that includes an application specific integrated circuit (ASIC). The memory stores a computer-readable instruction. Each section of the head-mounted display 100, the unlocking system, and the like according to the embodiments of the invention is implemented by causing the processor to execute the instruction. The memory may be a semiconductor memory (e.g., static random access memory (SRAM) or dynamic random access memory (DRAM)), a register, a hard disk, or the like. The instruction may be an instruction included in an instruction set of a program, or may be an instruction that causes a hardware circuit of the processor to operate.

### 4. Details of Process

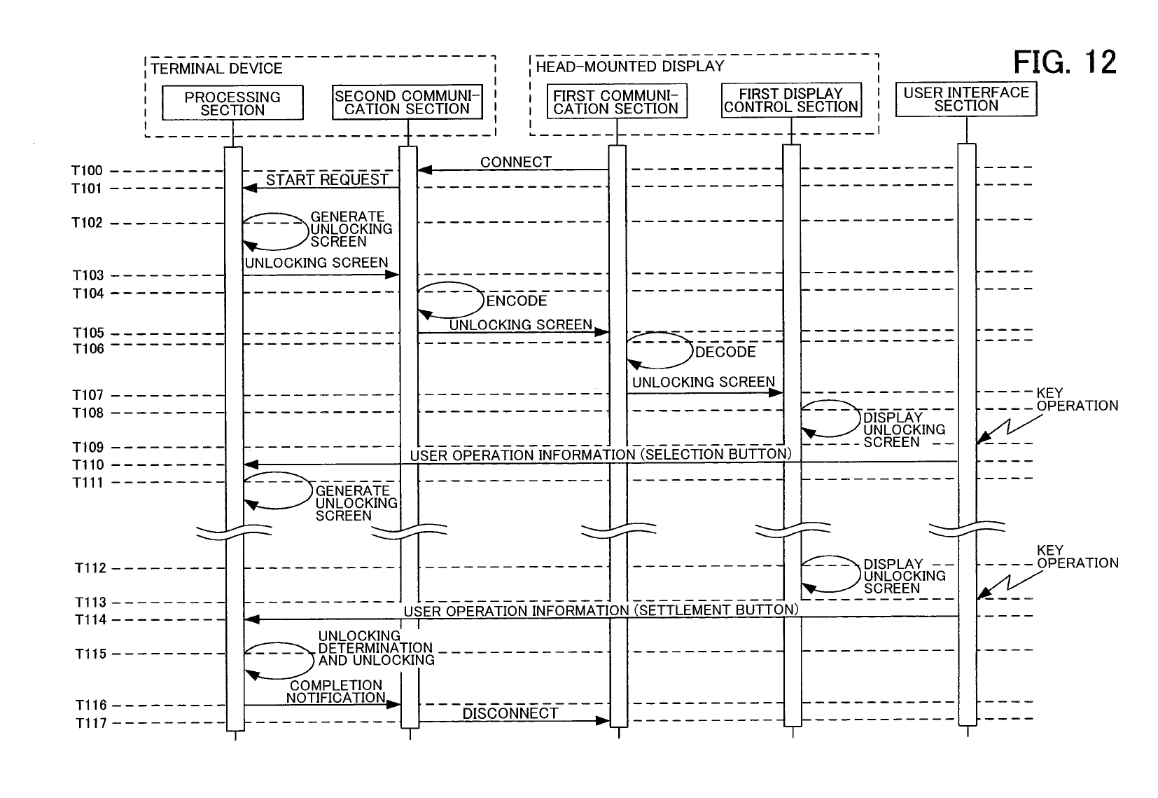

The flow of the process performed when unlocking the terminal device is described below with reference to FIG. 12 (sequence diagram). FIG. 12 (sequence diagram) illustrates the flow of the process when using the user interface section 300 as an input device in the third system configuration example illustrated in FIG. 5. Note that the first display section 110, the second display section 210, the second display control section 220, and the operation information acquisition section 140 are omitted for convenience of illustration.

The first communication section 150 of the head-mounted display 100 and the second communication section 250 of the terminal device 200 are connected through communication (T100), and the second communication section 250 transmits an unlocking process start request to the processing section 130 of the terminal device 200 (T101).

The processing section 130 generates the unlocking screen (T102), and transmits information about the unlocking screen to the second communication section 250 (T103). The second communication section 250 encodes the information about the unlocking screen (T104), and transmits the encoded information about the unlocking screen to the first communication section 150 (T105).

The first communication section 150 decodes the received information about the unlocking screen (T106), and transmits the decoded information about the unlocking screen to the first display control section 120 (T107).

The first display control section 120 displays the unlocking screen on the first display section 110 of the head-mounted display 100 (T108).

When the user who has observed the unlocking screen has operated the user interface section (T109), the processing section 130 of the terminal device 200 acquires the user operation information (T110). The user operation information includes information that represents an optional image among a plurality of optional images that is set to the selected state, information that instructs to settle to select the optional image that has been set to the selected state, and the like. For example, the information that represents an optional image among a plurality of optional images that is set to the selected state (i.e., the operation information about the selection operation section) is received as the user operation information (T110).

The processing section 130 regenerates the unlocking screen based on the received user operation information (T111). In this example, the processing section 130 generates the unlocking screen in which the optional image that has been set to the selected state is set to a non-selected state, and another optional image is set to the selected state.

The steps T103 to T111 are repeated until the optional image that is desired for the user is set to the selected state. The first display control section 120 displays the unlocking screen in which the optional image that is desired for the user is set to the selected state, on the first display section 110 (T112), and the user performs a key operation that settles to select the optional image that has been set to the selected state (T113).

The processing section 130 of the terminal device 200 acquires the user operation information that represents that the selection settlement operation section has been operated (T114). The processing section 130 determines whether or not the selection pattern coincides with the unlocking pattern (T115). When it has been determined that the selection pattern coincides with the unlocking pattern, the processing section 130 unlocks the terminal device 200 (T115).

The processing section 130 transmits a completion notification to the second communication section 250 (T116), the second communication section 250 disconnects from the first communication section 150 (T117), and the unlocking process is terminated.

When it has been determined that the selection pattern does not coincide with the unlocking pattern (T115), the processing section 130 generates the unlocking screen again, and the process is performed again (from T103). In this case, the processing section 130 may generate the unlocking screen in which the order of arrangement or the arrangement positions of the optional images is changed, and the generated unlocking screen may be displayed on the display section, for example.

Although only some embodiments of the invention have been described in detail above, those skilled in the art will readily appreciate that many modifications are possible in the embodiments without materially departing from the novel teachings and advantages of the invention. Accordingly, all such modifications are intended to be included within scope of the invention. Any term cited with a different term having a broader meaning or the same meaning at least once in the specification and the drawings can be replaced by the different term in any place in the specification and the drawings. The configuration and the operation of the head-mounted display 100 and the unlocking system are not limited to those described in connection with the above embodiments. Various modifications and variations may be made of the above embodiments.

What is claimed is:

1. A head-mounted display that is worn on a head of a user, the head-mounted display comprising:
a display section that displays a display image; and
a display control section that performs a control process that displays the display image on the display section,
the display control section displaying an unlocking screen on the display section, the unlocking screen being used by the user to unlock the head-mounted display, and displaying an unlocked state notification screen on the display section when the head-mounted display has been unlocked using the unlocking screen, the unlocked state notification screen notifying the user that the head-mounted display has been unlocked.

2. The head-mounted display as defined in claim 1, further comprising:
an operation information acquisition section that acquires user operation information; and
a processing section that determines whether or not the head-mounted display has been unlocked based on the user operation information that has been input using the unlocking screen,
the display control section displaying the unlocking screen in which a plurality of optional images are arranged, on the display section, and
the processing section specifying an optional image that has been selected from among the plurality of optional images arranged within the unlocking screen based on the acquired user operation information, determining whether or not a selection pattern of the optional image selected by the user coincides with an unlocking pattern, and determining that the head-mounted display has been unlocked when it has been determined that the selection pattern coincides with the unlocking pattern.

3. The head-mounted display as defined in claim 2,
the display control section displaying the unlocking screen in which the plurality of optional images are arranged in one row or one column, or the unlocking screen in which the plurality of optional images are arranged in a two-dimensional array having i rows and j columns (i and j are positive integers, provided that at least one of i and j is equal to or larger than 2), on the display section.

4. The head-mounted display as defined in claim 2,
the display control section displaying the unlocking screen in which the plurality of optional images are arranged at random positions, on the display section.

5. The head-mounted display as defined in claim 2,
the display control section displaying a first unlocking screen on the display section as the unlocking screen at a first display timing, and displaying a second unlocking screen on the display section as the unlocking screen at a second display timing that differs from the first display timing, the second unlocking screen differing from the first unlocking screen as to arrangement positions of the plurality of optional images.

6. The head-mounted display as defined in claim 2,
the display control section displaying the unlocking screen in which arrangement positions of the plurality of optional images are periodically changed, on the display section.

7. The head-mounted display as defined in claim 2,
the processing section setting an optional image among the plurality of optional images to an initial selected state at an initial selection timing, and
the display control section displaying the unlocking screen in which at least the optional image that has been set to the initial selected state is arranged, on the display section.

8. The head-mounted display as defined in claim 7,
the processing section setting a kth optional image among first to Nth optional images to the initial selected state at a first initial selection timing (N is a positive integer, and k is an integer that satisfies 1≦k≦N), and setting an mth optional image among the first to Nth optional images to the initial selected state at a second initial selection timing that differs from the first initial selection timing (m is an integer that satisfies 1≦m≦N and k≠m).

9. The head-mounted display as defined in claim 2,
the processing section specifying a selection direction based on the user operation information, the selection direction representing a direction in which an optional image among the plurality of optional images that is to be set to a selected state is situated within the unlocking screen with respect to an optional image among the plurality of optional images that has been set to the selected state.

10. The head-mounted display as defined in claim 9,
when the user operation information has been acquired by the operation information acquisition section when an rth optional image among first to Nth optional images has been set to the selected state (N is a positive integer, and r is an integer that satisfies 1≦r≦N),
the processing section setting the selection direction to a first direction at a first selection timing, setting an sth optional image that is situated in the first direction with respect to the rth optional image within the unlocking screen to the selected state (s is an integer that satisfies 1≦s≦N and r≠s), setting the selection direction to a second direction that differs from the first direction at a second selection timing that differs from the first selection timing, and setting a tth optional image that is situated in the second direction with respect to the rth optional image within the unlocking screen to the selected state (t is an integer that satisfies 1≦t≦N and r≠t).

11. The head-mounted display as defined in claim 2,
the operation information acquisition section acquiring a motion sensor signal that represents a motion of the head of the user from a motion sensor as the user operation information, and
the processing section specifying the motion of the head of the user based on the motion sensor signal, and specifying a selection direction based on the motion of the head of the user, the selection direction representing a direction in which an optional image among the plurality of optional images that is to be set to a selected state is situated within the unlocking screen with respect to an optional image among the plurality of optional images that has been set to the selected state.

12. The head-mounted display as defined in claim 2,
the operation information acquisition section acquiring the user operation information from a user interface section that includes a selection operation section for performing a selection operation, and a selection settlement operation section for performing a selection settlement operation, and
the processing section setting an optional image among the plurality of optional images that has been set to a selected state to a non-selected state, and setting another optional image among the plurality of optional images to the selected state when it has been detected that the selection operation section has been operated based on the user operation information, and settling that the optional image that has been set to the selected state is selected when it has been detected that the selection settlement operation section has been operated based on the user operation information.

13. The head-mounted display as defined in claim 2,
the operation information acquisition section acquiring the user operation information from a terminal device that includes a touch panel that displays the display image, and detects the user operation information.

14. The head-mounted display as defined in claim 1,
the display control section displaying the unlocking screen in which a plurality of optional images are arranged, on the display section, and displaying the unlocked state notification screen on the display section when it has been determined that a selection pattern that has been specified based on the user operation information coincides with an unlocking pattern, the selection pattern being a pattern of optional images among the plurality of optional images that have been selected by the user.

15. The head-mounted display as defined in claim 14,
the display control section displaying a first unlocking screen on the display section as the unlocking screen at a first display timing, and displaying a second unlocking screen on the display section as the unlocking screen at a second display timing that differs from the first display timing, the second unlocking screen differing from the first unlocking screen as to arrangement positions of the plurality of optional images.

16. The head-mounted display as defined in claim 14,
the display control section displaying the unlocking screen in which an optional image among the plurality of optional images that has been set to an initial selected state at an initial selection timing is arranged, on the display section.

17. The head-mounted display as defined in claim 16,
the display control section displaying the unlocking screen in which a kth optional image among first to Nth optional images has been set to the initial selected state at a first initial selection timing, on the display section (N is a positive integer, and k is an integer that satisfies 1≦k≦N), and displaying the unlocking screen in which an mth optional image among the first to Nth optional images has been set to the initial selected state at a second initial selection timing that differs from the first initial selection timing, on the display section (m is an integer that satisfies 1≦m≦N and k≠m).

18. The head-mounted display as defined in claim 14, further comprising:
an operation information acquisition section that acquires user operation information,
when the user operation information has been acquired by the operation information acquisition section when an rth optional image among first to Nth optional images has been set to a selected state (N is a positive integer, and r is an integer that satisfies 1≦r≦N),
the display control section displaying the unlocking screen in which an sth optional image that is situated in a first direction with respect to the rth optional image is set to the selected state, on the display section at a first selection timing (s is an integer that satisfies 1≦s≦N and r≠s), and displaying the unlocking screen in which a tth optional image that is situated in a second direction that differs from the first direction with respect to the rth optional image is set to the selected state, on the display section at a second selection timing that differs from the first selection timing (t is an integer that satisfies 1≦t≦N and r≠t).

19. The head-mounted display as defined in claim 14, further comprising:
an operation information acquisition section that acquires the user operation information from a user interface section that includes a selection operation section for performing a selection operation, and a selection settlement operation section for performing a selection settlement operation,
the display control section displaying the unlocking screen in which an optional image among the plurality of optional images that has been set to a selected state is set to a non-selected state, and another optional image among the plurality of optional images is set to the selected state, on the display section when it has been detected that the selection operation section has been operated based on the user operation information, and displaying the unlocking screen in which it is settled that the optional image that has been set to the selected state is selected, on the display section when it has been detected that the selection settlement operation section has been operated based on the user operation information.

20. An unlocking system comprising:
a head-mounted display; and
a terminal device that is communicably connected to the head-mounted display,
the head-mounted display including:
a first display section that displays a first display image; and
a first display control section that performs a control process that displays the first display image on the first display section,
the terminal device including:
a second display section that displays a second display image; and
a second display control section that performs a control process that displays the second display image on the second display section,
the head-mounted display or the terminal device including:
a processing section that performs an unlocking determination process; and
an operation information acquisition section that acquires user operation information,
the first display control section displaying an unlocking screen for unlocking the head-mounted display on the first display section,
the processing section determining whether or not the head-mounted display has been unlocked based on the user operation information that has been input using the unlocking screen, and
the first display control section displaying an unlocked state notification screen on the first display section when it has been determined that the head-mounted display has been unlocked, the unlocked state notification screen notifying that the head-mounted display has been unlocked.

21. The unlocking system as defined in claim 20,
the first display control section displaying the unlocking screen on the first display section during an unlocking process, and
the second display control section setting the second display section to a non-display state during the unlocking process, and setting the second display section to a display state when the processing section has determined that the head-mounted display has been unlocked.

22. A method for controlling an unlocking system that includes a head-mounted display, and a terminal device that is communicably connected to the head-mounted display, the method comprising:
displaying an unlocking screen for unlocking the head-mounted display on a first display section of the head-mounted display;
performing a display control process on a second display section of the terminal device;
acquiring user operation information;
determining whether or not the head-mounted display has been unlocked based on the acquired user operation information; and
displaying an unlocked state notification screen on the first display section when it has been determined that the head-mounted display has been unlocked, the unlocked state notification screen notifying that the head-mounted display has been unlocked.
